(19) United States
(12) Patent Application Publication
(10) Pub. No.: US 2025/0053290 A1
(43) Pub. Date: Feb. 13, 2025

(54) METHOD, ELECTRONIC DEVICE, AND STORAGE MEDIUM FOR MULTIMEDIA RESOURCE PROCESSING

(71) Applicant: TENCENT TECHNOLOGY (SHENZHEN) COMPANY LIMITED, Shenzhen (CN)

(72) Inventor: Keyu ZHAI, Shenzhen (CN)

(21) Appl. No.: 18/932,159

(22) Filed: Oct. 30, 2024

Related U.S. Application Data
(63) Continuation of application No. PCT/CN2023/092950, filed on May 9, 2023.

(30) Foreign Application Priority Data
Nov. 28, 2022 (CN) 202211505104.9

(51) Int. Cl. G06F 3/04847; G06F 3/0483

(52) U.S. Cl. CPC G06F 3/04847; G06F 3/0483

(57) ABSTRACT

A multimedia resource processing method includes: displaying a first resource display page, a sharing control and a first resource picture being there-displayed on, the sharing control configured to share a target multimedia resource, the target multimedia resource having a plurality of resource pictures, and the first resource picture being one of the plurality of resource pictures or being one resource picture representing the target multimedia resource; displaying a resource segment selection control in the first resource display page, a second resource picture being displayed on the resource segment selection control, and the second resource picture being at least one of the plurality of resource pictures of the target multimedia resource; obtaining a selected resource picture in the second resource picture, and determining a first resource segment according to the selected resource picture; and transmitting the first resource segment comprising the selected resource picture to another terminal device.

### CROSS-REFERENCES TO RELATED APPLICATIONS

This application is a continuation application of PCT Patent Application No. PCT/CN2023/092950, filed on May 9, 2023, which claims priority to Chinese Patent Application No. 202211505104.9, filed on Nov. 28, 2022, all of which is incorporated by reference in their entirety.

### FIELD OF THE TECHNOLOGY

Embodiments of the present disclosure relate to the field of computer technologies and, in particular, to method, apparatus, electronic device, and storage medium for multimedia resource processing.

### BACKGROUND OF THE DISCLOSURE

With the continuous development of computer technologies, a user can conveniently share a multimedia resource of interest, such as a video or audio, with another user through a terminal device.

When a sharing instruction for a target multimedia resource is received, a playing address of the target multimedia resource is obtained; a sharing link of the target multimedia resource is generated according to the playing address of the target multimedia resource; and the sharing link is transmitted to a terminal device of the another user, to share the target multimedia resource with the another user in the form of the sharing link.

### SUMMARY

One embodiment of the present disclosure provides a multimedia resource processing method, performed by a terminal device. The method includes: displaying a first resource display page, a sharing control and a first resource picture being displayed on the first resource display page, the sharing control being configured to share a target multimedia resource, the target multimedia resource having a plurality of resource pictures, and the first resource picture being one of the plurality of resource pictures, or the first resource picture being one resource picture representing the target multimedia resource; displaying a resource segment selection control in the first resource display page in response to a trigger operation for the sharing control, a second resource picture being displayed on the resource segment selection control, and the second resource picture being at least one of the plurality of resource pictures of the target multimedia resource; obtaining a selected resource picture in the second resource picture, and determining a first resource segment according to the selected resource picture in the second resource picture; and transmitting the first resource segment to another terminal device, the first resource segment comprising the selected resource picture in the second resource picture.

Another embodiment of the present disclosure provides a computer device. The computer device includes one or more processors and a memory containing at least one piece of program code that, when being executed, causes the one or more processors to perform: displaying a first resource display page, a sharing control and a first resource picture being displayed on the first resource display page, the sharing control being configured to share a target multimedia resource, the target multimedia resource having a plurality of resource pictures, and the first resource picture being one of the plurality of resource pictures, or the first resource picture being one resource picture representing the target multimedia resource; displaying a resource segment selection control in the first resource display page in response to a trigger operation for the sharing control, a second resource picture being displayed on the resource segment selection control, and the second resource picture being at least one of the plurality of resource pictures of the target multimedia resource; obtaining a selected resource picture in the second resource picture, and determining a first resource segment according to the selected resource picture in the second resource picture; and transmitting the first resource segment to another terminal device, the first resource segment comprising the selected resource picture in the second resource picture.

Another embodiment of the present disclosure provides a non-transitory computer-readable storage medium containing at least one piece of program code that, when being executed, causes at least one processor to perform: displaying a first resource display page, a sharing control and a first resource picture being displayed on the first resource display page, the sharing control being configured to share a target multimedia resource, the target multimedia resource having a plurality of resource pictures, and the first resource picture being one of the plurality of resource pictures, or the first resource picture being one resource picture representing the target multimedia resource; displaying a resource segment selection control in the first resource display page in response to a trigger operation for the sharing control, a second resource picture being displayed on the resource segment selection control, and the second resource picture being at least one of the plurality of resource pictures of the target multimedia resource; obtaining a selected resource picture in the second resource picture, and determining a first resource segment according to the selected resource picture in the second resource picture; and transmitting the first resource segment to another terminal device, the first resource segment comprising the selected resource picture in the second resource picture.

### BRIEF DESCRIPTION OF THE DRAWINGS

FIG. 1 is a schematic diagram of an implementation environment of a multimedia resource sharing method according to an embodiment of the present disclosure.

FIG. 2 is a flowchart of a multimedia resource sharing method according to an embodiment of the present disclosure.

FIG. 3 is a schematic diagram of displaying a target page according to an embodiment of the present disclosure.

FIG. 4 is a schematic diagram of displaying a first resource display page according to an embodiment of the present disclosure.

FIG. 5 is a schematic diagram of displaying another first resource display page according to an embodiment of the present disclosure.

FIG. 6 is a schematic diagram of displaying another first resource display page according to an embodiment of the present disclosure.

FIG. 7 is a schematic diagram of displaying another first resource display page according to an embodiment of the present disclosure.

FIG. 8 is a schematic diagram of displaying a first page according to an embodiment of the present disclosure.

FIG. 9 is a schematic diagram of displaying a second resource display page according to an embodiment of the present disclosure.

FIG. 10 is another schematic diagram of displaying second resource display page according to an embodiment of the present disclosure.

FIG. 11 is a schematic diagram of displaying a first control and a second control according to an embodiment of the present disclosure.

FIG. 12 is a schematic diagram of displaying a resource picture included in a resource segment corresponding to a target control according to an embodiment of the present disclosure.

FIG. 13 is a flowchart of a multimedia resource sharing method according to an embodiment of the present disclosure.

FIG. 14 is a flowchart of a multimedia resource sharing method according to an embodiment of the present disclosure.

FIG. 15 is a flowchart of a multimedia resource sharing method according to an embodiment of the present disclosure.

FIG. 16 is a flowchart of a multimedia resource sharing method according to an embodiment of the present disclosure.

FIG. 17 is a schematic diagram of a multimedia resource sharing method according to an embodiment of the present disclosure.

FIG. 18 is a schematic diagram of a multimedia resource sharing method according to an embodiment of the present disclosure.

FIG. 19 is a schematic structural diagram of a multimedia resource sharing apparatus according to an embodiment of the present disclosure.

FIG. 20 is a schematic structural diagram of a multimedia resource sharing apparatus according to an embodiment of the present disclosure.

FIG. 21 is a schematic structural diagram of a terminal device according to an embodiment of the present disclosure.

FIG. 22 is a schematic structural diagram of a server according to an embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

Embodiments of the present disclosure provide method, apparatus, electronic device, and storage medium for multimedia resource processing, which at least resolves problems that a multimedia resource has a non-diversified sharing manner and poor sharing flexibility.

Abbreviations and key terms involved in the embodiments of the present disclosure are defined as follows.

Shared waveform graph: it is a waveform graph formed based on a quantity of times that a video clip is shared, where a high waveform represents a large quantity of times that a video clip is shared.

Intercepting scale: It refers to a clip selection structure in which a start point time and an end point time may be changed when a video clip is selected. Alternatively, by using the intercepting scale, at least one of the start point time and the end point time of the selected video clip can be changed.

Preview cursor: It refers to a structure in which pictures at different moments in a video clip may be intercepted through a sliding preview when the clip is selected. That is to say, by using the preview cursor, a picture corresponding to at least one moment in the intercepted clip (that is, the selected video clip) can be previewed.

itemCF: It is item-based collaborative filtering. A model of collaborative filtering is as follows: for m items and m pieces of user data, score data exists between only partial user data in the m items and partial the item data in the m pieces of user data. By using existing score data between the user data and the item data (that is, the existing score data between the partial user data and the partial item data), a score relationship (that is, score data) between other user data and other item data is predicted, and an item with a highest score (that is, score data) is found and recommended to a user.

FIG. 1 is a schematic diagram of an implementation environment of a multimedia resource sharing method according to an embodiment of the present disclosure (because sharing is a type of processing, each multimedia resource sharing method in the embodiments of the present disclosure may be considered as a multimedia resource processing method). As shown in FIG. 1, the implementation environment includes: a first terminal device 101, a second terminal device 102, and a server 103.

An application program that can support multimedia resource sharing is installed and run in both the first terminal device 101 and the second terminal device 102.

The server 103 is configured to provide background services for the application program that can support multimedia resource sharing and that is installed in the first terminal device 101 and the second terminal device 102. In one embodiment, the server 103 undertakes primary computing work, and the first terminal device 101 (or the second terminal device 102) undertakes secondary computing work. Alternatively, the server 103 undertakes secondary computing work, and the first terminal device 101 (or the second terminal device 102) undertakes primary computing work. Alternatively, collaborative computing is performed by using a distributed computing architecture between the first terminal device 101 (or the second terminal device 102) and the server 103.

Each of the first terminal device 101 and the second terminal device 102 is any electronic device product that can perform human-computer interaction with a user through one or more manners such as a keyboard, a touchpad, a touch screen, a remote control, voice interaction, or a handwriting device, for example, a personal computer (PC), a mobile phone, a smart phone, a personal digital assistant (PDA), a wearable device, a Pocket PC (PPC), a tablet computer, a smart on-board unit, a smart television, or a smart speaker. The server 102 may be a server, a server cluster including a plurality of server units, or a cloud computing service center. A communication connection is established between any two of the first terminal device 101, the second terminal device 102, and the server 103 through a wired network or a wireless network.

A person skilled in the art can understand that the first terminal device 101, the second terminal device 102, and the server 103 are merely examples for description. Other terminal devices or servers that are existing or may appear in future, if they are applicable to the present disclosure, are also to fall within the protection scope of the present disclosure, and are incorporated herein by reference.

In the related art, during sharing of a multimedia resource, when a sharing instruction for the target multimedia resource is received, a playing address of the target multimedia resource is obtained; a sharing link of the target multimedia resource is generated according to the playing address of the target multimedia resource; and the sharing link is transmitted to a terminal device of the another user, to share the target multimedia resource with the another user in the form of the sharing link. However, the multimedia resource has a non-diversified sharing manner and poor sharing flexibility. As a result, it is difficult for the user to share the multimedia resource according to an actual requirement.

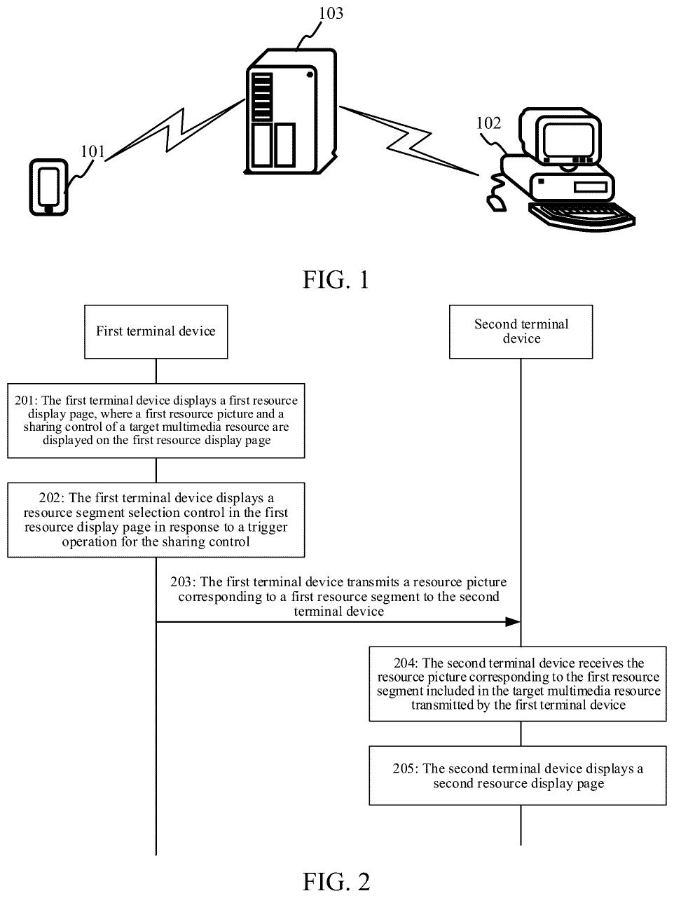

An embodiment of the present disclosure provides a multimedia resource sharing method. The method may be applied to the foregoing implementation environment shown in FIG. 1. A flowchart of a multimedia resource sharing method according to an embodiment of the present disclosure shown in FIG. 2 is used as an example. The method may be implemented by interaction between the first terminal device 101 and the second terminal device 102 in FIG. 1. As shown in FIG. 2, the method includes the following operations.

Operation 201. The first terminal device displays a first resource display page, where a first resource picture and a sharing control of a target multimedia resource are displayed on the first resource display page.

The sharing control and the first resource picture are displayed on the first resource display page, the sharing control is configured to share the target multimedia resource, for example, share at least one resource segment of a plurality of resource segments included in the target multimedia resource.

In an exemplary embodiment of the present disclosure, an application program that can support multimedia resource sharing is installed and run in the first terminal device. The application program may be an application program that needs to be downloaded and installed, or may be an embedded program, such as an applet, that is run in dependence on a host program. This is not limited in the embodiments of the present disclosure. For example, an embedded program that is run in dependence on a host program refers to: The host program provides an entrance of the embedded program. During running of the host program, in response to detecting that the entrance of the embedded program is selected, the host program jumps to the embedded program, so that the embedded program runs. Certainly, if the host program exits running, the embedded program also exits running. The host program may be an application program that needs to be downloaded and installed.

Related information of the application program is displayed on a display interface of the first terminal device. The related information of the application program may be an icon of the application program or a name of the application program. This is not limited in the embodiments of the present disclosure. In response to a trigger operation for the related information of the application program, a target page is displayed. One or more multimedia resources are displayed on the target page. Resource information of each multimedia resource may be further displayed on the target page. The resource information may be at least one of a resource name, object information of a resource posting object, a resource posting time, and a resource posting address. The object information of the resource posting object may be at least one of an avatar of the resource posting object and an object name of the resource posting object. The trigger operation for the related information of the application program may be a selection operation for the related information of the application program. The multimedia resource may be a video, audio, or audio-video. This is not limited in the embodiments of the present disclosure.

For example, the target multimedia resource has a plurality of resource pictures. When the target multimedia resource is a video, the plurality of resource pictures of the target multimedia resource refer to a plurality of resource pictures included in the target multimedia resource. When the target multimedia resource is audio, the plurality of resource pictures of the target multimedia resource refer to a plurality of resource pictures corresponding to the target multimedia resource, for example, a plurality of waveform graphs corresponding to the audio. When the target multimedia resource is audio-video, the plurality of resource pictures of the target multimedia resource include at least one type of resource pictures of a plurality of resource pictures included in the video and a plurality of resource pictures corresponding to the audio.

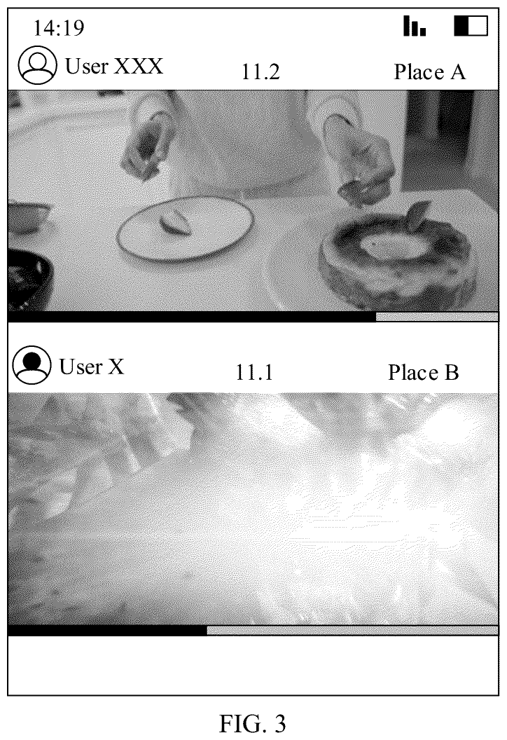

FIG. 3 is a schematic diagram of displaying a target page according to an embodiment of the present disclosure. Two multimedia resources and resource information of each multimedia resource are displayed. A first multimedia resource has a resource posting object of “user XXX”, a resource posting time of “11.2”, and a resource posting address of “place A”. A second multimedia resource has a resource posting object of “user X”, a resource posting time of “11.1”, and a resource posting address of “place B”.

Certainly, there may be more or fewer multimedia resources displayed on the target page. This is not limited in the embodiments of the present disclosure. FIG. 3 is merely described above by using an example in which two multimedia resources are displayed on the target page.

When a first object using a first terminal device intends to view a target multimedia resource of a plurality of multimedia resources, the first object selects the target multimedia resource. The first terminal device receives a trigger operation for the target multimedia resource and displays a first resource display page, where a first resource picture of a target multimedia resource and a sharing control are displayed on the first resource display page. The trigger operation for the target multimedia resource may be a trigger operation for resource information of the target multimedia resource, or may be a trigger operation for the target multimedia resource, or may be in another manner. This is not limited in the embodiments of the present disclosure. The first resource picture is one of a plurality of resource pictures. For example, the first resource picture of the target multimedia resource may be the first resource picture of the target multimedia resource, or may be any resource picture of the target multimedia resource. For example, the target multimedia resource has resource pictures 1 to 10, and the first resource picture is one of the resource pictures 1 to 10. Alternatively, the first resource picture may be a resource picture that can represent the target multimedia resource. For example, the first resource picture is a resource picture other than the plurality of resource pictures of the target multimedia resource. For example, the target multimedia resource has 10 resource pictures. The first resource picture is not one of the 10 resource pictures, but another resource picture that can represent the target multimedia resource. This is not limited in the embodiments of the present disclosure either.

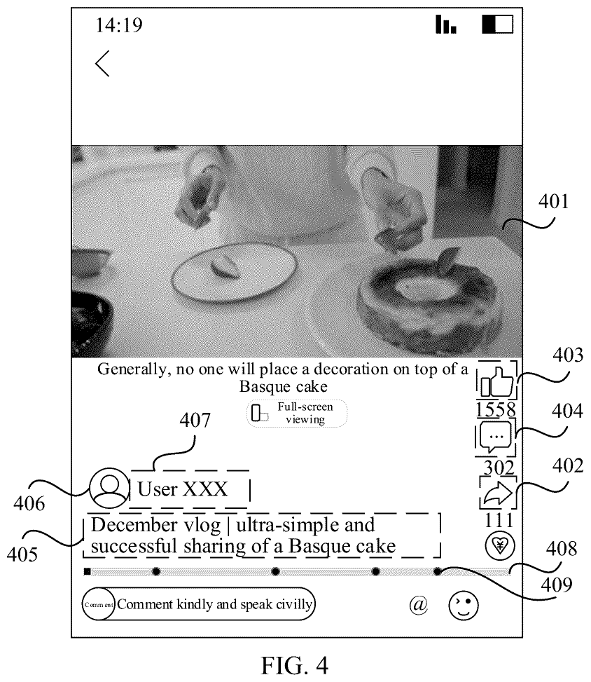

FIG. 4 is a schematic diagram of displaying a first resource display page according to an embodiment of the present disclosure. A first resource picture 401 and a sharing control 402 of a target multimedia resource are displayed on the first resource display page. In one embodiment, a sharing count may be further displayed on the first resource display page. The sharing count is configured for indicating a quantity of times that the target multimedia resource is shared. As shown in FIG. 4, “111” below the sharing control is the sharing count, indicating that the target multimedia resource is shared 111 times.

In one embodiment, a like giving control and a quantity of likes may be further displayed on the first resource display page. The like giving control is configured to give a like to the target multimedia resource, and the quantity of likes is a quantity of obtained likes to the target multimedia resource. As shown in FIG. 4, 403 is the like giving control; and “1558” is the quantity of likes, indicating that 1558 likes to the target multimedia resource have been obtained. A comment control and a quantity of comments may be further displayed on the first resource display page. The comment control is configured to obtain a comment on the target multimedia resource, and the quantity of comments is configured for indicating a quantity of obtained comments on the target multimedia resource. As shown in FIG. 4, 404 is the comment control; and “302” is the quantity of comments, indicating that 302 comments on the target multimedia resource have been obtained.

A resource name of the target multimedia resource, an avatar of a resource posting object of the target multimedia resource, and an object name of the resource posting object may be further displayed on the first resource display page. As shown in FIG. 4, 405 is a resource name of the target multimedia resource, 406 is an avatar of a resource posting object of the target multimedia resource, and 407 is an object name of the resource posting object of the target multimedia resource.

In one embodiment, a progress bar of the target multimedia resource may be further displayed on the first resource display page, at least one second mark is displayed on the progress bar, and the second mark is configured for indicating a resource segment included in the target multimedia resource. The second mark is configured for instructing to split the target multimedia resource into a plurality of resource segments. A quantity of resource segments into which the target multimedia resource is split greater than a quantity of second marks by one. As shown in FIG. 4, 408 is a progress bar of the target multimedia resource, and 409 is a second mark. FIG. 4 shows four second marks (namely, circular black marks shown in FIG. 4), indicating that the target multimedia resource is split into five resource segments, which are: the content before the first second-mark is the first resource segment, the content between the first second-mark and the second second-mark is the second resource segment, the content between the second second-mark and the third second-mark is the third resource segment, the content between the third second-mark and the fourth second-mark is the fourth resource segment, and the content after the fourth second-mark is the fifth resource segment.

Operation 202. The first terminal device displays a resource segment selection control in the first resource display page in response to a trigger operation for the sharing control.

When the first object intends to share the target multimedia resource, the first object selects the sharing control, and the first terminal device receives a trigger operation for the sharing control, and then displays the resource segment selection control in the first resource display page. Selectable resource pictures of the target multimedia resource at a plurality of times are displayed on the resource segment selection control. In other words, resource pictures of the target multimedia resource at a plurality of times are displayed on the resource segment selection control, and the resource picture at each time is a selectable resource picture. The resource pictures of the target multimedia resource at the plurality of times are the second resource pictures. That is to say, a second resource picture is displayed on the resource segment selection control, and the second resource picture is at least one of the plurality of resource pictures of the target multimedia resource. In other words, one or more second resource pictures are displayed on the resource segment selection control, and the one or more second resource pictures are one or more of the plurality of resource pictures of the target multimedia resource.

For example, the second resource pictures are part of the plurality of resource pictures of the target multimedia resource. In this way, displaying excessive resource pictures in the resource segment selection control to affect viewing is avoided. In this case, the first resource picture and the second resource pictures have the following two relationships:

Relationship 1: the second resource pictures include the first resource picture. For example, if the target multimedia resource has 10 resource pictures 1 to 10, the second resource pictures are resource pictures 1, 3, 5, 7, and 9 among the 10 resource pictures, and the first resource picture is 5, the second resource pictures include the first resource picture.

Relationship 2: the second resource pictures do not include the first resource picture. For example, if the second resource pictures are still the resource pictures 1, 3, 5, 7, and 9 among the 10 resource pictures, and the first resource picture is 6, the second resource pictures do not include the first resource picture. For another example, if the second resource pictures are still the resource pictures 1, 3, 5, 7, and 9, and the first resource picture does not belong to the resource pictures 1 to 10, the second resource pictures similarly do not include the first resource picture.

For another example, the second resource pictures are all of the plurality of resource pictures of the target multimedia resource. For example, the target multimedia resource has resource pictures 1 to 10, and the second resource pictures are the 10 resource pictures. In this case, the second resource pictures are the target multimedia resource. Therefore, the relationship between the second resource pictures and the first resource picture is the relationship between the target multimedia resource and the first resource picture in the foregoing description. Details are not described herein again.

In one embodiment, an intercepting scale is further displayed on the resource segment selection control. A resource picture covered by the intercepting scale is a resource picture corresponding to the first resource segment. The resource picture corresponding to the first resource segment includes a selected resource picture at the at least one time in the resource pictures at the plurality of times. A start time of the first resource segment is a first time. An end time of the first resource segment is a second time. Each resource picture included in the plurality of resource pictures corresponds to one time in the target multimedia resource. Using one resource picture per second as an example, in the plurality of resource pictures of the target multimedia resource, the first resource picture corresponds to the 1st second, the second resource picture corresponds to the 2nd second, and so on. The resource picture covered by the intercepting scale represents the selected resource picture.

In one embodiment, before the resource pictures of the target multimedia resource at the plurality of times are displayed on the resource segment selection control (it is merely an example, and an occasion for determining the first resource segment is not limited in the embodiments of the present disclosure), the first resource segment needs to be determined first. Manners of determining the first resource segment include but are not limited to the following three manners.

Implementation 1: Use any one of the plurality of resource segments included in the target multimedia resource as the first resource segment.

Implementation 2: Use a resource segment with a largest sharing count among the plurality of resource segments included in the target multimedia resource as the first resource segment.

In one embodiment, the first terminal device obtains the plurality of resource segments included in the target multimedia resource and a sharing count of each resource segment. A resource segment with a largest sharing count is used as the first resource segment.

Implementation 3: Determine, in response to the trigger operation for the sharing control, a third time corresponding to a resource picture displayed on the first resource display page in the target multimedia resource when the sharing control is triggered, that is, determine the third time corresponding to the resource picture displayed on the first resource display page when the sharing control is triggered, where the resource picture displayed on the first resource display page when the sharing control is triggered is one of the plurality of resource pictures. For example, when the first resource display page is just displayed in operation 201, the first resource picture is displayed on the first resource display page, and then the target multimedia resource (including the resource pictures 1 to 10 as an example) starts to play. If the resource picture 6 is exactly played when the sharing control is triggered, the resource picture 6 is the resource picture displayed on the first resource display page when the sharing control is triggered, and the time corresponding to the resource picture 6 in the target multimedia resource is the third time. Then, the first resource segment is determined according to the third time.

The process of determining the first resource segment according to the third time includes: using a time corresponding to a resource picture whose sharing count in resource pictures corresponding to times in a target period of time satisfies a count requirement as the first time, or using, in resource pictures corresponding to times in a target period of time, a time corresponding to a resource picture whose sharing count satisfies a count requirement as the first time, where the resource pictures corresponding to the times in the target period of time are at least one of the plurality of resource pictures; determining candidate resource segments in resource segments whose start times are the first time; using an end time of a candidate resource segment whose sharing count satisfies the count requirement among the candidate resource segments as the second time; and using a resource picture between the first time and the second time as the first resource segment.

A start time of the target period of time is a start time of the target multimedia resource, and an end time of the target period of time is the third time. End times of the candidate resource segments are not earlier than the third time. The resource picture whose sharing count satisfies the count requirement refers to a resource picture with a highest sharing count. The candidate resource segment whose sharing count satisfies the count requirement refers to a candidate resource segment with a highest sharing count. If there are a plurality of resource pictures with the highest sharing count, a time corresponding to any one of the plurality of resource pictures with the highest sharing count is used as the first time. if there are a plurality of candidate resource segments with the highest sharing count, an end time of any one of the plurality of candidate resource segments with the highest sharing count is used as the second time.

The first terminal device obtains sharing counts of resource pictures at times of the target multimedia resource. After determining the third time, the first terminal device determines a target period of time according to the third time; and determines sharing counts of resource pictures at times in the target period of time, and uses a time of a resource picture with the highest sharing count in the target period of time as the first time.

A manner in which the first terminal device obtains sharing counts of resource pictures at times of the target multimedia resource is not limited in this embodiment of the present disclosure. In one embodiment, there are the following two manners of obtaining sharing counts of resource pictures at times of the target multimedia resource.

Manner 1: The first terminal device has a resource identifier of the target multimedia resource and sharing counts of resource pictures at times of the target multimedia resource stored therein.

Manner 2: The server has resource identifiers of multimedia resources and sharing counts of resource pictures at times of the multimedia resources stored therein; and the first terminal device obtains sharing counts of resource pictures at times of a target multimedia resource through interaction with the server.

A process of Manner 2 includes: The first terminal device transmits a first obtaining request to the server, where the first obtaining request includes a resource identifier of a target multimedia resource. The server receives the first obtaining request, parses the first obtaining request to obtain the resource identifier of the target multimedia resource, and obtains sharing counts of resource pictures at times of the target multimedia resource according to the resource identifier of the target multimedia resource, resource identifiers of multimedia resources, and sharing counts of resource pictures at times of the multimedia resources. The server transmits sharing counts of resource pictures at times of the target multimedia resource to the first terminal device. That is to say, the first terminal device obtains sharing counts of resource pictures at times of the target multimedia resource.

Sharing counts of resource pictures at times of the target multimedia resource may be obtained in any one of the foregoing manners. This is not limited in the embodiments of the present disclosure.

For example, if the third time is 00:05, the target period of time ranges from 00:00 to 00:05. The sharing count of the resource picture at 00:01 is 3. The sharing count of the resource picture at 00:02 is 5. The sharing count of the resource picture at 00:03 is 8. The sharing count of the resource picture at 00:04 is 2. The sharing count of the resource picture at 00:05 is 5. The sharing count of the resource picture at 00:03 is highest. Therefore, 00:03 is used as the first time.

After the first time is determined, a second time is determined based on the first time. The first terminal device obtains start times, end times, and sharing counts of a plurality of resource segments included in the target multimedia resource; uses a resource segment with the start time being the first time and the end time being not earlier than the third time in the plurality of resource segments as a candidate resource segment; and uses an end time of a candidate resource segment whose sharing count satisfies the count requirement among the candidate resource segments as the second time.

The manner of obtaining start times, end times, and sharing counts of a plurality of resource segments included in the target multimedia resource includes: The first terminal device generates a second obtaining request, the second obtaining request including a resource identifier of the target multimedia resource, and the second obtaining request being configured for obtaining the start times, the end times, and the sharing counts of the plurality of resource segments included in the target multimedia resource. The first terminal device transmits the second obtaining request to the server. The server receives the second obtaining request, and parses the second obtaining request to obtain the resource identifier of the target multimedia resource. The server has resource identifiers of multimedia resources, and correspondences between start times, end times, and sharing counts of a plurality of resource segments included in the multimedia resources stored therein. The server obtains the start times, the end times, and the sharing counts of the plurality of resource segments included in the target multimedia resource according to the resource identifier of the target multimedia resource, the resource identifiers of the multimedia resources, and the correspondences between the start times, the end times, and the sharing counts of the plurality of resource segments included in the multimedia resources. The server transmits the start times, the end times, and the sharing counts of the plurality of resource segments included in the target multimedia resource to the first terminal device, so that the first terminal device obtains the start times, the end times, and the sharing counts of the plurality of resource segments included in the target multimedia resource.

For example, the target multimedia resource includes five resource segments, where the first resource segment has a start time of 00:03, an end time of 00:20, and a sharing count of 3, the second resource segment has a start time of 00:05, an end time of 00:40, and a sharing count of 1, the third resource segment has a start time of 00:03, an end time of 00:33, and a sharing count of 5, the fourth resource segment has a start time of 01:10, an end time of 01:15, and a sharing count of 1, and the fifth resource segment has a start time of 01:20, an end time of 01:33, and a sharing count of 4. The first time is 00:03, and the third time is 00:05. Therefore, the first resource segment and the third resource segment are used as candidate resource segments. Because the third resource segment has the highest sharing count, the end time of the third resource segment is used as the second time. That is to say, the second time is 00:33. A resource picture between 00:03 and 00:33 is used as the first resource segment.

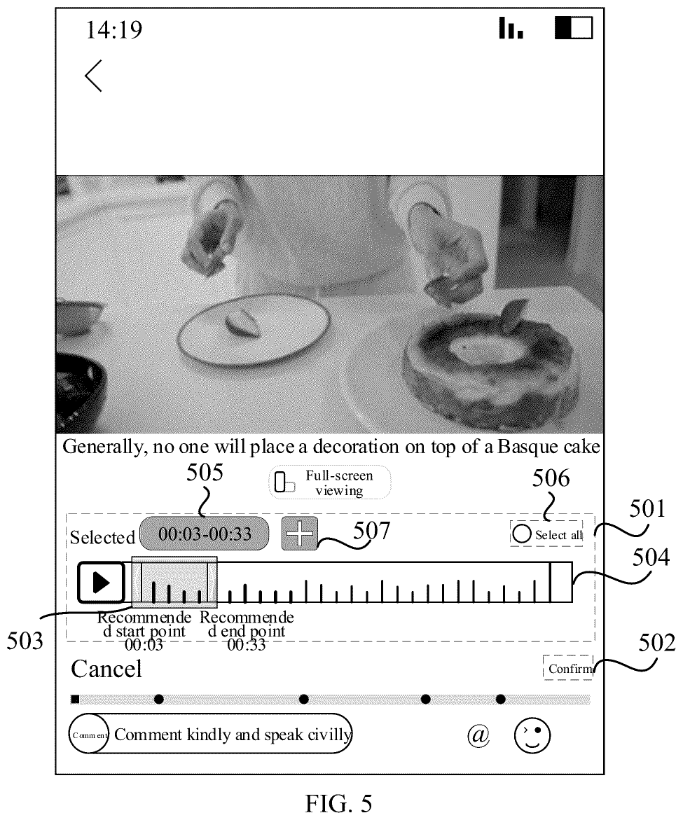

FIG. 5 is a schematic diagram of displaying another first resource display page according to an embodiment of the present disclosure. A resource segment selection control 501 is displayed on the first resource display page. Resource pictures of the target multimedia resource at a plurality of times and an intercepting scale 503 are displayed on the resource segment selection control. A resource picture display box 504 is further displayed on the resource segment selection control, and the resource picture display frame is configured to display resource pictures of the target multimedia resource at a plurality of times.

A time display area may be further displayed on the resource segment selection control, and the time display area is configured for displaying the start time of the first resource segment and the end time of the first resource segment. That is to say, the time display area is configured to display the first time and the second time. As shown in FIG. 5, 505 is a time display area. As shown in FIG. 5, the first time is 00:03, and the second time is 00:33.

Certainly, the intercepting scale displayed on the resource segment selection control may be further moved left and right to adjust the start time and/or the end time of the first resource segment. When the intercepting scale is moved, the start time and/or the end time of the first resource segment also changes, and the start time and/or the end time of the first resource segment displayed in the time display area also changes. The intercepting scale includes a lower limit on the left and an upper limit on the right. The lower limit is configured for indicating the start time of the first resource segment. The upper limit is configured for indicating the end time of the first resource segment. There is a distance between the lower limit and the upper limit. The distance indicates duration of the first resource segment. For example, that the intercepting scale is moved left and right may mean that the intercepting scale is moved as a whole without individually moving the lower limit and the upper limit of the intercepting scale, so that the duration indicated by the distance between the lower limit and the upper limit does not change, but the start time indicated by the lower limit and the end time indicated by the upper limit both change. Alternatively, that the intercepting scale is moved left and right may mean that at least one of the lower limit and the upper limit of the intercepting scale is moved individually, so that the duration indicated by the distance between the lower limit and the upper limit can change, and at least one of the start time indicated by the lower limit and the end time indicated by the upper limit changes. In some implementations, When the lower limit of the intercepting scale is individually moved to cause the lower limit to be on the right side of the upper limit, or when the upper limit of the intercepting scale is individually moved to cause the upper limit to be on the left side of the lower limit, the lower limit and the upper limit are exchanged to ensure that the first resource segment has the start time earlier than the end time.

In one embodiment, a select-all control may be further displayed on the resource segment selection control. The select-all control is configured to instruct to use the target multimedia resource as the first resource segment. As shown in FIG. 5, 506 is the select-all control. In response to a trigger operation for the select-all control, the selected resource picture that corresponds to the first resource segment and that is in the resource segment selection control is changed to resource pictures corresponding to the target multimedia resource (the plurality of resource pictures of the target multimedia resource). When the first object intends to share the entire target multimedia resource, the first object selects the select-all control. The first terminal device receives the trigger operation for the select-all control, and changes the selected resource picture that corresponds to the first resource segment and that is in the resource segment selection control to resource pictures corresponding to the target multimedia resource.

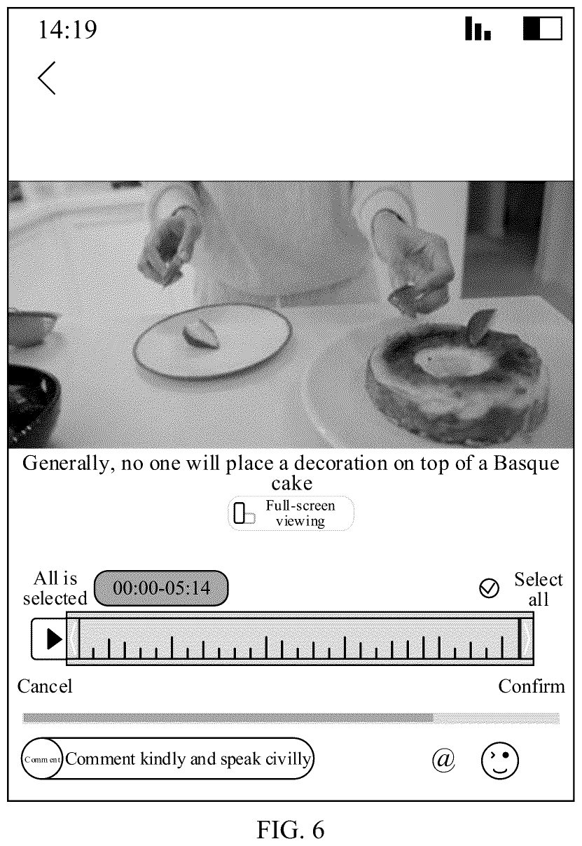

FIG. 6 is a schematic diagram of displaying another first resource display page according to an embodiment of the present disclosure. When the select-all control is selected, the resource picture covered by the intercepting scale displayed on the resource segment selection control is changed from the resource picture corresponding to the first resource segment to the resource picture corresponding to the target multimedia resource. The first resource segment displayed in the time display area has the start time changed from 00:03 to 00:00 and the end time changed from 00:33 to 05:14.

In some embodiments, a waveform graph is further displayed on the resource segment selection control, and the waveform graph is configured for indicating sharing counts of resource pictures of the target multimedia resource at times. A higher waveform at any time indicates a larger sharing count of the resource picture at any time. On the contrary, a lower waveform at any time indicates a smaller sharing count of the resource picture at any time. Displaying the waveform graph in the resource segment selection control can visually indicate sharing counts of resource pictures of the target multimedia resource at times, so that the first object can easily determine resource picture sharing statuses of the target multimedia resource at the times.

In one embodiment, a resource segment adding control is further displayed on the resource segment selection control, and the resource segment adding control is configured to instruct to determine, based on that the first resource segment is determined, a second resource segment to be shared in the plurality of resource segments included in the target multimedia resource. As shown in FIG. 5, 507 is the resource segment adding control.

When the first object intends to share a plurality of resource segments at a time, the first object selects the resource segment adding control, and the first terminal device receives a trigger operation for the resource segment adding control, and changes a selected resource picture corresponding to the first resource segment (also referred to as a resource picture included in the first resource segment) in the resource segment selection control to a resource picture corresponding to the second resource segment (also referred to as a resource picture included in the second resource segment), that is, changes the selected resource picture in the resource segment selection control from the resource picture included in the first resource segment to the resource picture included in the second resource segment. A correlation degree between the second resource segment and the first resource segment satisfies a correlation degree requirement. That the selected resource picture corresponding to the first resource segment is changed to the resource picture corresponding to the second resource segment does not mean that the resource picture corresponding to the first resource segment is no longer selected, but means that the resource picture corresponding to the second resource segment is additionally selected based on that the resource picture corresponding to the first resource segment is selected. In this way, after the first resource segment to be shared is determined, the second resource segment whose correlation degree with the first resource segment satisfies the correlation degree requirement is determined, and the first resource segment and the second resource segment are shared together, that is, (the resource picture included/corresponding to) the first resource segment and (the resource picture included/corresponding to) the second resource segment are transmitted to the second terminal device. For example, the resource picture covered by the intercepting scale displayed on the resource segment selection control is changed from the resource picture corresponding to the first resource segment to the resource picture corresponding to the second resource segment.

When the selected resource picture corresponding to the first resource segment in the resource segment selection control is changed to the resource picture corresponding to the second resource segment, the resource picture corresponding to the first resource segment displayed on the resource segment selection control further needs to be displayed in the first form. The first form is configured for indicating that the start time and the end time of the first resource segment cannot be adjusted. Alternatively, the first form is configured for indicating that the start time of the first resource segment and the end time of the first resource segment remain unchanged. For example, the displaying the resource picture corresponding to the first resource segment in the first form may be displaying the resource picture corresponding to the first resource segment in black. The displaying the resource picture corresponding to the first resource segment in the first form may alternatively be locking the resource picture corresponding to the first resource segment, so that the start time and the end time of the first resource segment are not adjusted by the first object, thereby avoiding misadjustment of the first resource segment by the first object and improving the accuracy of human-computer interaction.

In one embodiment, the second resource segment further needs to be determined in the target multimedia resource first before the selected resource picture corresponding to the first resource segment in the resource segment selection control is changed to the resource picture corresponding to the second resource segment. The process of determining the second resource segment in the target multimedia resource includes: obtaining a first feature vector of the first resource segment in response to the trigger operation for the resource segment adding control; obtaining a second feature vector of each reference resource segment; determining a correlation degree between each reference resource segment and the first resource segment according to the second feature vector of the reference resource segment and the first feature vector of the first resource segment; and using a reference resource segment whose correlation degree satisfies the correlation degree requirement as the second resource segment.

The first feature vector is configured for representing a resource picture corresponding to the first resource segment. The reference resource segment is a resource segment in which resource pictures included in the plurality of resource segments included in the target multimedia resource are not duplicated with a resource picture corresponding to the first resource segment. Alternatively, the reference resource segment is at least one of the plurality of resource segments included in the target multimedia resource, and a resource picture corresponding to the reference resource segment is not duplicated with the resource picture corresponding to the first resource segment. A second feature vector of any reference resource segment is configured for representing a resource picture corresponding to the any reference resource segment (also referred to as a resource picture included in the any reference resource segment). The reference resource segment whose correlation degree satisfies the correlation degree requirement refers to the reference resource segment with the highest correlation degree. If there are a plurality of reference resource segments with the highest correlation degree, any one of the plurality of reference resource segments with the highest correlation degree is used as the second resource segment.

In one embodiment, before the second feature vector of each reference resource segment is obtained, a plurality of reference resource segments further need to be obtained first. The process of obtaining the plurality of reference resource segments includes: segmenting the target multimedia resource to obtain a plurality of resource segments included in the target multimedia resource; and using a resource segment in the plurality of resource segments other than a target resource segment as the reference resource segment, where a resource picture corresponding to the target resource segment (also referred to as a resource picture included in the target resource segment) is duplicated with the resource picture corresponding to the first resource segment.

For example, after the target multimedia resource is segmented, in addition to the plurality of resource segments included in the target multimedia resource, the start time and the end time of each resource segment may be further obtained. In this case, when the reference resource segment is determined in the plurality of resource segments, whether each resource segment is the target resource segment may be determined according to the start time and the end time of each resource segment. For example, if the start time and/or the end time of a resource segment lies between the start time and the end time of the first resource segment, it is considered that a resource picture corresponding to the resource segment is duplicated with a resource picture corresponding to the first resource segment, so that the resource segment is used as the target resource segment. After the target resource segment is determined, resource segments other than the target resource segment in the plurality of resource segments may be used as reference resource segments. A manner of determining the target resource segment is not limited in the embodiments of the present disclosure.

The process of segmenting the target multimedia resource includes: performing semantic understanding on resource content of the target multimedia resource, to obtain a plurality of resource segments included in the target multimedia resource and a start time and an end time of each resource segment. Alternatively, in this embodiment of the present disclosure, the target multimedia resource may be evenly divided into a specified quantity of resource segments. A manner of segmenting the target multimedia resource is not limited herein, and the specified quantity may be determined empirically or based on an actual requirement.

A process of obtaining the first feature vector of the first resource segment is not limited in the embodiments of the present disclosure. For example, the first feature vector of the first resource segment is obtained in, including but not limited to, the following three implementations.

Implementation 1: Input the first resource segment into a feature vector determining model, and obtain the first feature vector of the first resource segment according to an output result of the feature vector determining model.

The feature vector determining model is any neural network model. This is not limited in the embodiments of the present disclosure. For example, the feature vector determining model is a Long Short Term Memory (LSTM) model.

Implementation 2: Perform audio/picture separation on the first resource segment to obtain audio and a resource picture of the first resource segment, to obtain a resource picture and audio at each time; and determine a corresponding result of the resource picture and the audio at each time; and obtain the first feature vector of the first resource segment according to the corresponding result of the resource picture and the audio at each time.

A process of determining the corresponding result of the resource picture and the audio at each time is similar. In this embodiment of the present disclosure, only the process of determining the corresponding result of the resource picture and the audio at any time is used as an example for description. A resource picture at any time is parsed, to obtain parsed text corresponding to the resource picture at the any time; audio at the any time is converted into words, to obtain audio text at the any time; and a similarity between the parsed words corresponding to the resource picture at the any time and the audio text at the any time is determined, and the similarity is used as the correspondence result of the resource picture and the audio at the any time.

In one embodiment, the process of determining a similarity between the parsed words corresponding to the resource picture at the any time and the audio text at the any time includes: determining a first quantity of words that are jointly included in the parsed words corresponding to the resource picture at the any time and the audio text at the any time; and using a quotient of the first quantity and a quantity of words included in the audio text at the any time as the similarity between the parsed words corresponding to the resource picture at the any time and the audio text at the any time.

For example, the first resource segment has the start time of 00:03 and the end time of 00:06, and it is determined that in the first resource segment, a corresponding result of the resource picture and the audio at 00:03 is 0.9; a corresponding result of the resource picture and the audio at 00:04 is 0.8; a corresponding result of the resource picture and the audio at 00:05 is 0.5; and a corresponding result of the resource picture and the audio at 00:06 is 0.3. Then, the first feature vector of the first resource segment is (0.9, 0.8, 0.5, 0.3).

Implementation 3: Perform audio/picture separation on the first resource segment to obtain a resource picture of the first resource segment, to obtain a resource picture at each time; parse a resource picture at each time, to obtain parsed text corresponding to the resource picture at each time; extract text information at each time from the resource picture at each time; determine a similarity between the parsed text corresponding to the resource picture at each time and the text information at each time; and determine the first feature vector of the first resource segment according to the similarity between the parsed text corresponding to the resource picture at each time and the text information at each time.

A process of determining a similarity between the parsed text corresponding to the resource picture at each time and the text information at each time is similar. In this embodiment of the present disclosure, only the process of determining the similarity between the parsed text corresponding to the resource picture at any time and the text information at the any time is used as an example for description. The process includes: determining a second quantity of words that are jointly included in the parsed text corresponding to the resource picture at the any time and the text information at the any time; and using a quotient of the second quantity and a quantity of words included in the text information at the any time as the similarity between the parsed text corresponding to the resource picture at the any time and the text information at the any time.

For example, the first resource segment has the start time of 00:03 and the end time of 00:06, and it is determined that in the first resource segment, a similarity between the parsed text corresponding to the resource picture and the text information at 00:03 is 0.2; a similarity between the parsed text corresponding to the resource picture and the text information at 00:04 is 0.4; a similarity between the parsed text corresponding to the resource picture and the text information at 00:05 is 0.9; and a similarity between the parsed text corresponding to the resource picture and the text information at 00:06 is 0.6. Then, the first feature vector of the first resource segment is (0.2, 0.4, 0.9, 0.6).

Three implementations of obtaining the first feature vector of the first resource segment are described above. For example, in this embodiment of the present disclosure, weighted summation may be further performed on the feature vectors obtained in any two of the foregoing three implementations, to obtain the feature vector of the first resource segment.

Any one of the foregoing manners may be selected to obtain the first feature vector of the first resource segment. This is not limited in the embodiments of the present disclosure. A process of obtaining the second feature vector of each reference resource segment is similar to the foregoing process of obtaining the first feature vector of the first resource segment. Details are not described herein again.

After the first feature vector of the first resource segment and the second feature vector of each reference resource segment are obtained, a process of determining the correlation degree between each reference resource segment and the first resource segment is similar. The following only uses a process of determining the correlation degree between any reference resource segment and the first resource segment as an example for description. The process includes: a cosine distance between the second feature vector of the any reference resource segment and the first feature vector of the first resource segment is determined, and the cosine distance is used as the correlation degree between the any reference resource segment and the first resource segment.

For example, the first feature vector of the first resource segment is (A_1, B_1, C_1, D_1), and the second feature vector of the any reference resource segment is (A_2, B_2, C_2, D_2). Then, the correlation degree between the any reference resource segment and the second resource segment is A_1*A_2+B_1*B_2+C_1*C_2+D_1*D_2.

For example, the target multimedia resource is segmented, to obtain five resource segments included in the target multimedia resource; and a start time and an end time of each resource segment are: the resource segment 1 has a start time of 00:00 and an end time of 01:30; the resource segment 2 has a start time of 01:31 and an end time of 02:22; the resource segment 3 has a start time of 02:23 and an end time of 03:38; the resource segment 4 has a start time of 03:39 and an end time of 04:44; and the resource segment 5 has a start time of 04:45 and an end time of 05:14. The first resource segment has a start time of 00:03 and an end time of 00:33. Since resource pictures between the start time and the end time of the resource segment 1 include resource pictures included in the first resource segment, the resource segment 2, the resource segment 3, the resource segment 4, and the resource segment 5 are used as reference resource segments. It is determined that the correlation degrees between the resource segments and the first resource segment are respectively: 0.3, 0.9, 0.5, and 0.7. Since the correlation degree between the resource segment 3 and the first resource segment is the highest, the resource segment 3 is used as the second resource segment. Therefore, selected resource pictures corresponding to the first resource segment in the resource segment selection control are changed to resource pictures between 02:23 and 03:38. That is to say, resource pictures covered by the intercepting scale and displayed on the resource segment selection control are changed to resource pictures between 02:23 and 03:38.

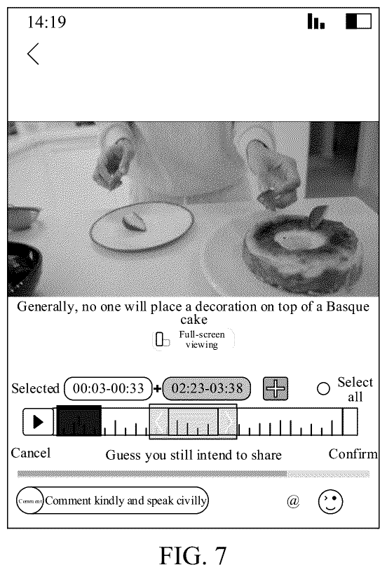

FIG. 7 is a schematic diagram of displaying another first resource display page according to an embodiment of the present disclosure. the intercepting scale displayed on the resource segment selection control has a start time of 02:23 and an end time of 03:38, and resource pictures between 00:03 and 00:33 are displayed in the first form (black). In addition, in the time display area, not only the first time and the second time (00:03 and 00:33) are displayed, but also the start time and the end time (02:23 and 03:38) of the second resource segment are displayed. In addition, text (guessing you intend to share still) is further displayed below the resource picture corresponding to the second resource segment, to guide the first object to share the second resource segment while sharing the first resource segment.

Similarly, the intercepting scale may be further moved left and right to adjust the start time and/or the end time of the second resource segment. When the start time and/or the end time of the second resource segment changes, and the start time and/or the end time of the second resource segment displayed in the time display area also changes. For the manner in which the intercepting scale is moved left and right, reference may be made to the foregoing descriptions. Details are not described herein again.

Operation 203. The first terminal device transmits a resource picture corresponding to a first resource segment to the second terminal device.

Operation 203 may also be considered as that the first terminal device transmits a first resource segment to the second terminal device, where the first resource segment includes a selected resource picture in a second resource picture, and the first resource segment is one of a plurality of resource segments included in the target multimedia resource.

Before performing operation 203, the first terminal device needs to obtain a selected resource picture in the second resource picture, to subsequently determine the first resource segment according to the selected resource picture. For example, the resource picture in the second resource picture can be selected by the first object, or the resource picture in the second resource picture can be automatically selected by the first terminal device, to obtain the selected resource picture in the second resource picture.

For example, the first terminal device may use any resource picture in the second resource picture as the selected resource picture, or may use a resource segment with the highest sharing count in the second resource picture as the selected resource picture. For another example, assuming that a start time of the first resource segment is a first time and an end time of the first resource segment is a second time, each resource picture included in the plurality of resource pictures of the target multimedia resource corresponds to a time in the target multimedia resource. Correspondingly, when the first terminal device selects a resource picture in the second resource picture, or when the first terminal device obtains the selected resource picture in the second resource picture, the first terminal device may determine, in response to the trigger operation for the sharing control, a third time corresponding to a resource picture displayed on the first resource display page when the sharing control is triggered, where the resource picture displayed on the first resource display page when the sharing control is triggered is one of the plurality of resource pictures. In resource pictures corresponding to times in a target period of time, a resource picture whose sharing count satisfies a requirement is used as the selected resource picture in the second resource picture. The start time of the target period of time is the start time of the second resource picture (for example, the time corresponding to the first resource picture in the second resource picture), and the end time of the target period of time is the third time. For example, when the second resource picture is the target multimedia resource, the start time of the target period of time is the start time of the target multimedia resource. For the manner of determining the resource picture whose sharing count satisfies the requirement, reference may be made to the description at implementation 3 in the foregoing manner of determining the first resource segment. Details are not described herein again.

Certainly, whether selected by the first object or automatically selected by the first terminal device, one or more of the second resource pictures may be selected, or a quantity of selected resource pictures in the second resource pictures may be one or more.

After the selected resource picture in the second resource picture is obtained, the first resource segment needs to be determined according to the selected resource picture, so that the first resource segment includes the selected resource picture in the second resource picture.

For example, the first resource segment may include only the selected resource picture in the second resource picture. For example, the second resource pictures are the resource pictures 1, 3, 5, 7, and 9, and the selected resource pictures are the resource pictures 3, 5, and 7. In this case, the first resource segment includes only the resource pictures 3, 5, and 7. For another example, the first resource segment may include both the selected resource picture in the second resource picture and another resource picture. For example, the first resource segment includes all resource pictures between the first selected resource picture in the second resource pictures and the last selected resource picture in the second resource pictures. An example in which the selected resource pictures in the second resource pictures are 3, 5, and 7 is still used. In this case, the first resource segment includes resource pictures 3, 4, 5, 6, and 7, where the resource picture 3 is the first selected resource picture, and the resource picture 7 is the last selected resource picture.

For example, when a resource picture whose sharing count satisfies a requirement in resource pictures corresponding to times in a target period of time is used as the selected resource picture in the second resource picture, a process in which the first terminal device determines the first resource segment according to the selected resource picture correspondingly includes: using a time corresponding to the selected resource picture in the second resource picture as the first time, and determining candidate resource segments in resource segments whose start times are the first time, where end times of the candidate resource segments are not earlier than the third time; using an end time of a candidate resource segment whose sharing count satisfies the count requirement among the candidate resource segments as the second time; and using a resource picture between the first time and the second time as the first resource segment. For a process of determining the first resource segment, reference may be made to the description at implementation 3 in the foregoing manner of determining the first resource segment. Details are not described herein again.

In one embodiment, a confirmation control is further displayed on the first resource display page. As shown in FIG. 5, a control 502 is a confirmation control. After determining the first resource segment, when the first object intends to share the first resource segment, the first object selects the confirmation control, the first terminal device receives a trigger operation for the confirmation control, and then displays a first page, where a resource sharing card and a plurality of sharing channel controls are displayed on the first page; and determines, in response to a trigger operation for a target channel sharing control of the plurality of channel sharing controls, a second object based on that the target channel sharing control is triggered, and then transmits the resource sharing card to the second terminal device used by the second object.

The resource sharing card is configured for sharing a resource picture corresponding to the first resource segment. A progress bar is displayed on the resource sharing card, the progress bar is a progress bar of the target multimedia resource, and a first reference mark and a second reference mark are displayed on the progress bar; and a time corresponding to the first reference mark on the progress bar is the first time, and a time corresponding to the second reference mark on the progress bar is the second time. A progress bar between the first reference mark and the second reference mark is displayed in a target form, and the target form is configured for instructing to share a resource picture between the first time and the second time. For example, displaying in the target form may be displaying in gray.

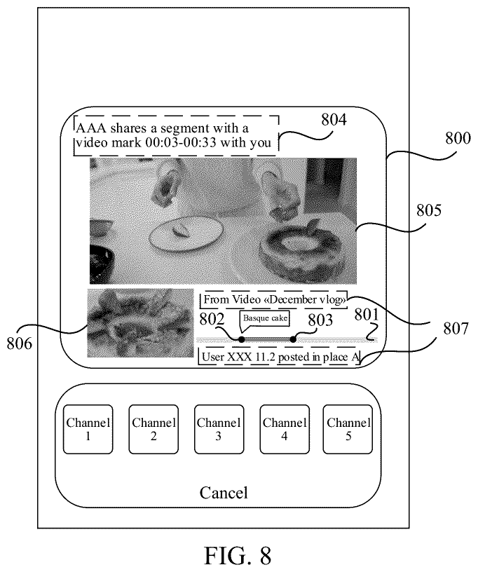

FIG. 8 is a schematic diagram of displaying a first page according to an embodiment of the present disclosure. A resource sharing card 800 is displayed. A progress bar 801 of a target multimedia resource is displayed on the resource sharing card. A first reference mark 802 and a second reference mark 803 are displayed on the progress bar. In addition, a progress bar between the first reference mark and the second reference mark is displayed in gray. As shown in FIG. 8, a channel 1 to a channel 5 are sharing channels.

Based on that a target sharing channel control is triggered, object information of friend objects included in the sharing channels corresponding to the target sharing channel control is displayed. In response to a trigger operation for object information of any friend object, the friend object is used as the second object. Alternatively, based on that the target sharing channel control is triggered, a friend object that has chatted last time among the friend objects included in the sharing channels corresponding to the target sharing channel control is used as the second object.

The object information of the friend object may be an avatar of the friend object, an object name of the friend object, or other information that can uniquely represent the friend object. This is not limited in the embodiments of the present disclosure.

In one embodiment, at least one of first prompt information, a first image, a second image, and second prompt information is displayed on the resource sharing card. The first prompt information is configured for indicating a position of the first resource segment in the target multimedia resource, the first image is any one of resource pictures included in the first resource segment, the second image is any resource picture included in the target multimedia resource (any one of the plurality of resource pictures of the target multimedia resource), the second prompt information is resource information of the target multimedia resource, and the resource information includes at least one of a resource name, object information of a resource posting object, a resource posting time, and a resource posting address. As shown in FIG. 8, 804 is the first prompt information, which indicates that position information of the first resource segment in the target multimedia resource is 00:03 to 00:33. 805 is the first image; and 806 is the second image. 807 is the second prompt information, which indicates that the resource name of the target multimedia resource is «December vlog», the object information of the resource posting object is user XXX, the resource posting time is 11.2, and the resource posting address is place A.

In one embodiment, a topic of the first resource segment may be further displayed on the resource sharing card. As shown in FIG. 8, “Basque cake” is a topic of the first resource segment. Before the topic of the first resource segment is displayed, the topic of the first resource segment further needs to be determined. A process of determining the topic of the first resource segment includes: performing semantic understanding on the first resource segment to obtain the topic of the first resource segment.

Certainly, when the first object shares a plurality of resource segments at a time, positions of the resource segments in the target multimedia resource and topics of the resource segments are displayed on the resource sharing card. A manner of determining a topic of each resource segment is similar.

For example, in addition to the foregoing resource sharing card, in this embodiment of the present disclosure, the resource picture corresponding to the first resource segment may be intercepted in the target multimedia resource, and then the resource picture corresponding to the first resource segment may be transmitted to the second terminal device used by the second object.

In one embodiment, after the first terminal device transmits the resource picture of the first resource segment to the second terminal device, the first terminal device adjusts the sharing count of the first resource segment. The process in which the first terminal device adjusts the sharing count of the first resource segment includes: The first terminal device increases the sharing count of the first resource segment by one. Alternatively, the first terminal device transmits a sharing count adjustment request to the server, the sharing count adjustment request carrying the first time and the second time, and the sharing count adjustment request being configured for instructing to increase the sharing count of the resource picture between the first time and the second time by one. The server increases the sharing count of the resource picture between the first time and the second time by one according to the sharing count adjustment request, to obtain an adjusted sharing count of the resource picture between the first time and the second time, that is, an adjusted sharing count of the first resource segment.

When there are a plurality of resource segments shared by the first terminal device with the second terminal device, the sharing count of each shared resource segment is adjusted. A process of adjusting sharing counts of other resource segments is similar to the foregoing process of adjusting the sharing count of the first resource segment. Details are not described herein again.

A quantity of resource segments shared by the first terminal device with the second terminal device is not limited in the embodiments of the present disclosure. When the quantity of resource segments shared by the first terminal device with the second terminal device is three, the third resource segment may be determined based on the first resource segment, or may be determined based on the second resource segment, or may be determined based on the first resource segment and the second resource segment. This is not limited in the embodiments of the present disclosure either. When the quantity of resource segments shared by the first terminal device with the second terminal device exceeds three, processes of determining other resource segments are similar to that of determining the third resource segment. Details are not described herein again.

Operation 204. The second terminal device receives the resource picture corresponding to the first resource segment included in the target multimedia resource transmitted by the first terminal device.

The second terminal device receives the first resource segment included in the target multimedia resource transmitted by the first terminal device, the target multimedia resource having a plurality of resource pictures, and the first resource segment including at least one of the plurality of resource pictures. In one embodiment, a start time of the first resource segment is a first time, and an end time of the first resource segment is a second time. The second terminal device and the first terminal device are communicatively connected through a wired network or a wireless network. The second terminal device receives the resource sharing card transmitted by the first terminal device, and the resource sharing card is configured to share the resource picture corresponding to the first resource segment included in the target multimedia resource.

In one embodiment, the second terminal device may further obtain a sharing count of each resource segment included in the target multimedia resource; and re-segment the target multimedia resource according to the sharing count of each resource segment, to obtain a plurality of resource segments obtained after the target multimedia resource is re-segmented. By re-segmenting the target multimedia resource based on the sharing count of each resource segment, the video quality of the target multimedia resource can be improved, so that the segmentation of the target multimedia resource is more consistent with the actual viewing situation of the user. In this way, the probability that the target multimedia resource is viewed can be improved, and the viewing efficiency of the user viewing the target multimedia resource can be improved.

The process of re-segmenting the target multimedia resource according to the sharing count of each resource segment, to obtain a plurality of resource segments obtained after the target multimedia resource is re-segmented includes: determining a resource segment 1 with the highest sharing count in the plurality of resource segments included in the target multimedia resource, and a first start time and a first end time corresponding to the resource segment 1; and determining a resource segment 2 with the highest sharing count from the start time of the target multimedia resource to the first start time, and a second start time and a second end time of the resource segment 2, determining a resource segment 3 with the highest sharing count from the first end time to the end time of the target multimedia resource, and a third start time and a third end time of the resource segment 3, and then using the resource segment 1, the resource segment 2, the resource segment 3, the resource picture between the start time of the target multimedia resource and the second start time, the resource picture between the second end time and the first start time, and the resource picture between the first end time and the third start time as the plurality of resource segments obtained after the target multimedia resource is re-segmented.

For example, total duration of the target multimedia resource is 01:30, a quantity of included resource segments is five, and each resource segment corresponds to a sharing count, which is as follows: the sharing count of the first resource segment (00:00 to 00:30) is 5; the sharing count of the second resource segment (00:15 to 00:40) is 7; the sharing count of the third resource segment (00:30 to 00:40) is 8; the sharing count of the fourth resource segment (00:55 to 01:12) is 10; the sharing count of the fifth resource segment (01:20 to 01:30) is 4. Therefore, the resource picture between 00:00 and 00:30, the third resource segment (corresponding to the foregoing resource segment 2), the resource picture between 00:40 and 00:55, the fourth resource segment (corresponding to the foregoing resource segment 1), the resource picture between 01:12 and 01:20, and the fifth resource segment (corresponding to the foregoing resource segment 3) are used as resource pictures obtained after the target multimedia resource is re-segmented.

Certainly, after the first terminal device shares the resource picture corresponding to the first resource segment with the second terminal device, the target multimedia resource may also be re-segmented. This process is similar to the process in which the second terminal device re-segments the target multimedia resource. Details are not described herein again.

Operation 205. The second terminal device displays a second resource display page.

The first image is displayed on the resource sharing card. When the second object that uses the second terminal device intends to view the first resource segment, the second object selects the first image. The second terminal device receives a trigger operation for the first image and displays the second resource display page. A target resource picture and a progress bar are displayed on the second resource display page. The target resource picture is a resource picture corresponding to the first time, the progress bar is a progress bar of the target multimedia resource, a first reference mark and a second reference mark are displayed on the progress bar, a time corresponding to the first reference mark on the progress bar is the first time, a time corresponding to the second reference mark on the progress bar is the second time, a progress bar between the first reference mark and the second reference mark is displayed in a target form, and the target form is configured for instructing to share a resource picture between the first time and the second time.

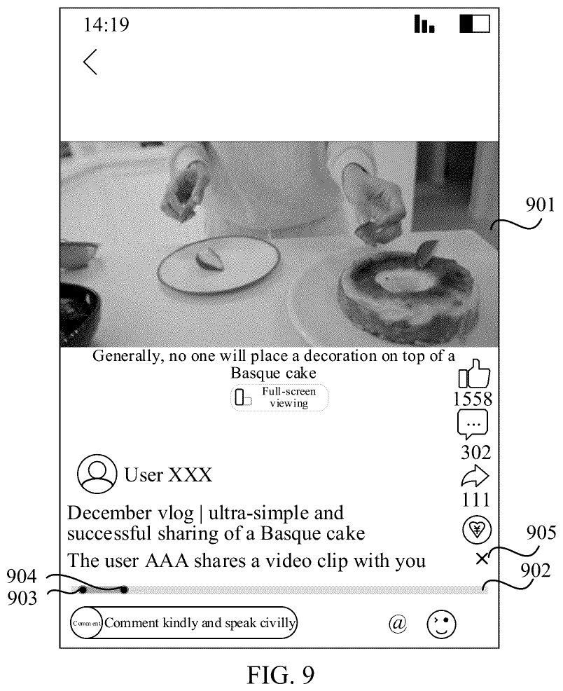

FIG. 9 is a schematic diagram of displaying a second resource display page according to an embodiment of the present disclosure. 901 is a target resource picture, 902 is a progress bar, 903 is a first reference mark, and 904 is a second reference mark.

In one embodiment, in response to that the resource sharing card is configured to share the first resource segment and the second resource segment in the target multimedia resource, a resource picture between the first time and the second time and a resource picture between a start time and an end time of the second resource segment are displayed on the second resource display page.

In one embodiment, the resource picture between the first time and the second time may be displayed first, and then the resource picture between the start time and the end time of the second resource segment is displayed. Alternatively, the resource picture between the start time and the end time of the second resource segment may be displayed first, and then the resource picture between the first time and the second time is displayed. The first time and the start time of the second resource segment may be further determined; and based on that the first time is earlier than the start time of the second resource segment, the resource picture between the first time and the second time is displayed first, and then the resource picture between the start time and the end time of the second resource segment is displayed. Based on that the first time is later than the start time of the second resource segment, the resource picture between the start time and the end time of the second resource segment is displayed first, and then the resource picture between the first time and the second time is displayed.

In one embodiment, third prompt information and a deactivation control corresponding to the third prompt information are further displayed on the second resource display page, the third prompt information is configured for indicating a quantity of resource segments shared by the first terminal device with the second terminal device, and the deactivation control is configured to instruct to cancel display of the resource segments shared by the first terminal device with the second terminal device; and As shown in FIG. 9, “User AAA shares a resource segment with you” is the third prompt information, and 905 is the deactivation control corresponding to the third prompt information.

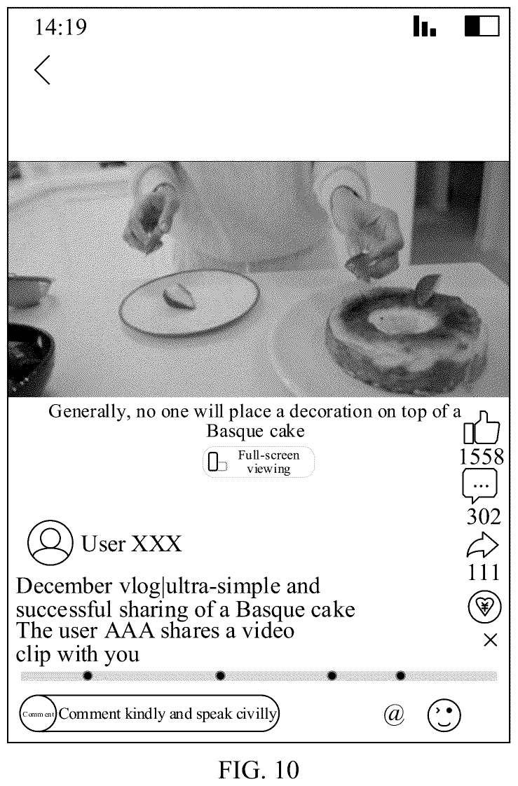

In response to a trigger operation for the deactivation control, display of the first reference mark and the second reference mark is canceled on the progress bar, and at least one second mark is displayed on the progress bar, where the second mark is configured for indicating a resource segment included in the target multimedia resource. FIG. 10 is a schematic diagram of displaying another second resource display page according to an embodiment of the present disclosure. The display of the first reference mark and the second reference mark is canceled, and four second marks are displayed on the progress bar, indicating that the target multimedia resource includes five resource segments.

A first control and a second control are displayed on the second resource display page in response to a target operation for any time on the progress bar. The target operation for any time refers to a touch and hold operation for the any time. The first control is configured to display segment information of a resource segment adjacent to a target resource segment and previous to the target resource segment, and the second control is configured to display segment information of a resource segment adjacent to the target resource segment and subsequent to the target resource segment. The target resource segment is a resource segment at the any time. The segment information includes at least one of a topic of the resource segment and a start time of the resource segment.

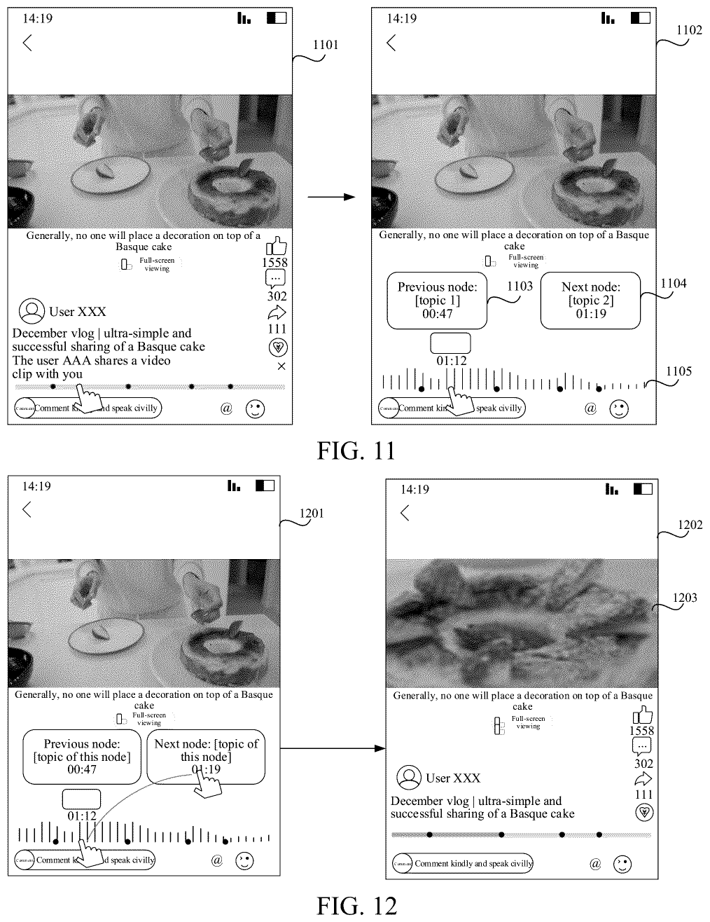

FIG. 11 is a schematic diagram of displaying a first control and a second control according to an embodiment of the present disclosure. A touch and hold operation for any time is received in 1101, and 1102 is displayed. A first control 1103 and a second control 1104 are displayed in 1102. A topic (topic 1) of a previous resource segment and a start time (00:47) of the previous resource segment are displayed on the first control. A topic (topic 2) of a next resource segment and a start time (01:19) of the next resource segment are displayed on the second control.

In one embodiment, in response to a target operation for any time on a progress bar, display of the progress bar is canceled, and a waveform graph is displayed. The waveform graph is configured for indicating sharing counts of resource pictures at times. As shown in FIG. 11, 1105 in 1102 is the waveform graph.

In one embodiment, when the second object intends to view the resource picture of the resource segment corresponding to the target control, the second object slides toward the target control from any time, and the second terminal device receives a slide operation to a target control from the any time, and displays a resource picture included in a resource segment corresponding to the target control in the second resource display page. The target control is either of the first control and the second control.

FIG. 12 is a schematic diagram of displaying a resource picture included in a resource segment corresponding to a target control according to an embodiment of the present disclosure. A slide operation to a second control from any time is received in 1201, and a resource picture 1203 included in a resource segment corresponding to the second control is displayed in 1202.

In the foregoing method, during sharing of a multimedia resource, when a trigger operation for a sharing control is received, a resource segment selection control is displayed on a first resource display page, and then a resource picture corresponding to a first resource segment is shared with a second terminal device. The resource picture corresponding to the first resource segment includes a selected resource picture at the at least one time in resource pictures at a plurality of times, so that resource sharing of the multimedia resource is more targeted, sharing manners of the multimedia resource are diversified, and sharing flexibility of the multimedia resource is improved. In other words, the foregoing method diversifies manners of processing a multimedia resource, thereby improving flexibility of processing a multimedia resource.

In addition, in the method, the first resource segment is determined according to the third time of the resource picture displayed on the first resource display page in the target multimedia resource when the trigger operation for the sharing control is received, so that the determined first resource segment is more consistent with the sharing requirement of the first object.

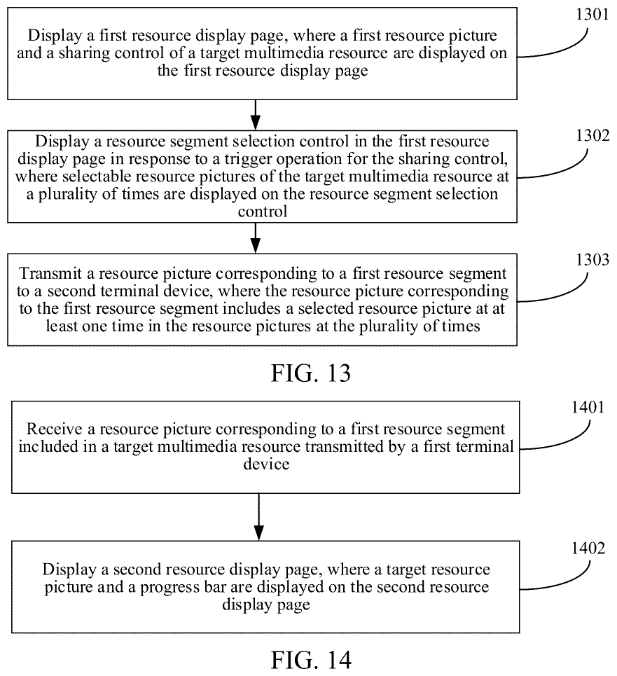

FIG. 13 is a flowchart of a multimedia resource sharing method according to an embodiment of the present disclosure. The method may be performed by the first terminal device 101 in FIG. 1. As shown in FIG. 13, the method includes the following operations.

Operation 1301. Display a first resource display page, where a first resource picture and a sharing control of a target multimedia resource are displayed on the first resource display page.

For example, a sharing control and a first resource picture are displayed on the first resource display page, the sharing control is configured to share a target multimedia resource, the target multimedia resource has a plurality of resource pictures, and the first resource picture is one of the plurality of resource pictures, or the first resource picture is one resource picture representing the target multimedia resource; In one embodiment, a process of displaying the first resource display page has been described in the foregoing operation 201, and details are not described herein again.

Operation 1302. Display a resource segment selection control in the first resource display page in response to a trigger operation for the sharing control, where (selectable) resource pictures of the target multimedia resource at a plurality of times are displayed on the resource segment selection control.

For example, a resource segment selection control is displayed on the first resource display page in response to a trigger operation for the sharing control, a second resource picture being displayed on the resource segment selection control, and the second resource picture being at least one of the plurality of resource pictures of the target multimedia resource. In one embodiment, a process of displaying the resource segment selection control in the first resource display page has been described in the foregoing operation 202, and details are not described herein again.

Operation 1303. Transmit a resource picture corresponding to a first resource segment to a second terminal device, where the resource picture corresponding to the first resource segment includes a selected resource picture at the at least one time in the resource pictures at the plurality of times.

For example, the first resource segment is transmitted to the second terminal device, the first resource segment including the selected resource picture in the second resource picture. In one embodiment, a process of transmitting the resource picture corresponding to the first resource segment to the second terminal device has been described in the foregoing operation 203, and details are not described herein again. Certainly, before operation 1303, the selected resource picture in the second resource picture further needs to be obtained, and the first resource segment is determined according to the selected resource picture in the second resource picture. For details of the obtaining manner, refer to the foregoing corresponding descriptions of FIG. 2. Details are not described herein again.

In the foregoing method, during sharing of a multimedia resource, when a trigger operation for a sharing control is received, a resource segment selection control is displayed on a first resource display page, and then a resource picture corresponding to a first resource segment is shared with a second terminal device. The resource picture corresponding to the first resource segment includes a selected resource picture at the at least one time in resource pictures at a plurality of times, so that resource sharing of the multimedia resource is more targeted, sharing manners of the multimedia resource are diversified, and sharing flexibility of the multimedia resource is improved.

FIG. 14 is a flowchart of a multimedia resource sharing method according to an embodiment of the present disclosure. The method may be performed by the second terminal device 102 in FIG. 1. As shown in FIG. 14, the method includes the following operations.

Operation 1401. Receive a resource picture corresponding to a first resource segment included in a target multimedia resource transmitted by a first terminal device.

For example, the first resource segment included in the target multimedia resource transmitted by the first terminal device is received. A start time of the first resource segment is a first time, and an end time of the first resource segment is a second time. The first resource segment includes a selected resource picture in a second resource picture, and the second resource picture is at least one of a plurality of resource pictures of the target multimedia resource.

In one embodiment, the process of receiving a resource picture corresponding to a first resource segment included in a target multimedia resource transmitted by a first terminal device has been described in the foregoing operation 204, and details are not described herein again.

Operation 1402. Display a second resource display page, where a target resource picture and a progress bar are displayed on the second resource display page.

The target resource picture is a resource picture corresponding to the first time, the progress bar is a progress bar of the target multimedia resource, a first reference mark and a second reference mark are displayed on the progress bar, a time corresponding to the first reference mark on the progress bar is the first time, a time corresponding to the second reference mark on the progress bar is the second time, a progress bar between the first reference mark and the second reference mark is displayed in a target form, and the target form is configured for instructing to share a resource picture between the first time and the second time.

In one embodiment, a process of displaying the second resource display page has been described in the foregoing operation 205, and details are not described herein again.

In the foregoing method, the resource picture corresponding to the first resource segment shared by the first terminal device is received, and then the resource picture corresponding to the first resource segment is displayed, so that resource sharing of the multimedia resource is more targeted, sharing manners of the multimedia resource are diversified, and sharing flexibility of the multimedia resource is improved.

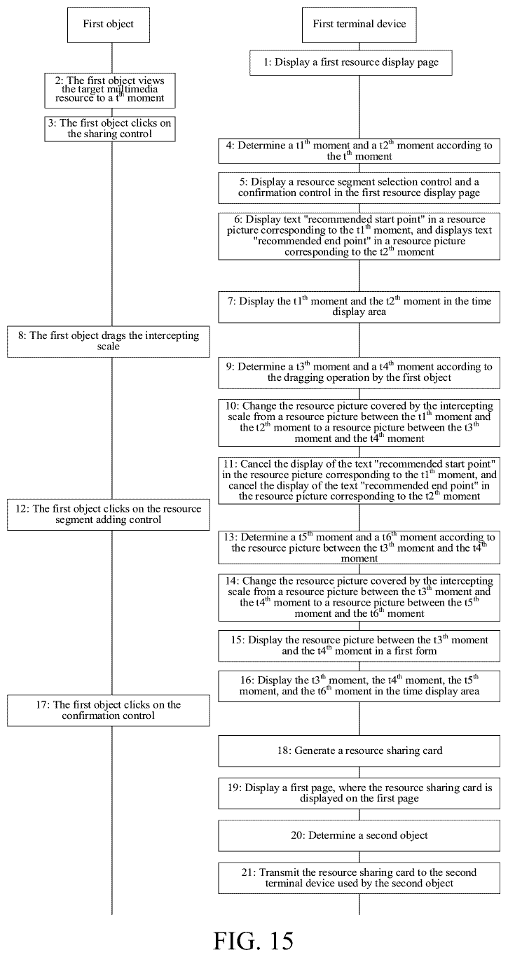

FIG. 15 is a flowchart of a multimedia resource sharing method according to an embodiment of the present disclosure. Execution bodies of the multimedia resource sharing method include a first object and a first terminal device. The first object is an object that uses the first terminal device. The method includes the following operations.

1: The first terminal device displays a first resource display page, where a first resource picture and a sharing control of a target multimedia resource are displayed on the first resource display page.

2: The first object views the target multimedia resource to a t^{th} moment.

3: The first object clicks on the sharing control.

4: The first terminal device determines a t1^{th} moment and a t2^{th} moment according to the t^{th} moment, and uses a resource picture between the t1^{th} moment and the t2^{th} moment as a first resource segment.

A process of determining a t1^{th} moment and a t2^{th} moment according to the t^{th} moment is similar to the process of determining the first time and the second time according to the third time in operation 202. Details are not described herein again.

5: The first terminal device displays a resource segment selection control and a confirmation control in the first resource display page. Resource pictures of the target multimedia resource at a plurality of times and an intercepting scale are displayed on the resource segment selection control, and a resource picture covered by the intercepting scale is a resource picture corresponding to the first resource segment.

6: The first terminal device displays text “recommended start point” in a resource picture corresponding to the t1^{th} moment, and displays text “recommended end point” in a resource picture corresponding to the t2^{th} moment.

This is to inform the first object that the first resource segment is a to-be-shared resource segment recommended to the first object.

7: A time display area is further displayed on the resource segment selection control. The first terminal device displays the t1^{th} moment and the t2^{th} moment in the time display area.

This process is similar to the process of displaying the first time and the second time in the time display area in operation 202 above. Details are not described herein again.

8: The first object drags the intercepting scale.

The purpose of dragging the intercepting scale is to change the start time and/or the end time of the first resource segment.

9: The first terminal device determines a t3^{th} moment and a t4^{th} moment according to the dragging operation by the first object. The t3^{th} moment is used as the start time of the first resource segment, and the t4^{th} moment is used as the end time of the first resource segment.

If the first object drags the left side of the intercepting scale and does not drag the right side of the intercepting scale, a moment obtained after dragging is used as the t3^{th} moment, the start time of the first resource segment is changed to the t3^{th} moment, and the end time is still the t2^{th} moment. If the first object drags the right side of the intercepting scale and does not drag the left side of the intercepting scale, a moment obtained after dragging is used as the 14^{th} moment, the start time of the first resource segment is still the 11^{th} moment, and the end time is changed to the t4^{th} moment.

10: The first terminal device changes the resource picture covered by the intercepting scale from a resource picture between the t1^{th} moment and the t2^{th} moment to a resource picture between the t3^{th} moment and the t4^{th} moment.

11: The first terminal device cancels the display of the text “recommended start point” in the resource picture corresponding to the 11^{th} moment, and cancels the display of the text “recommended end point” in the resource picture corresponding to the t2^{th} moment.

12: A resource segment adding control is further displayed on the resource segment selection control. The first object clicks on the resource segment adding control.

13: The first terminal device determines a t5^{th} moment and a t6^{th} moment according to the resource picture between the t3^{th} moment and the 4^{th} moment. The first terminal device determines, according to the resource picture between the t3^{th} moment and the t4^{th} moment, a second resource segment whose correlation degree with the resource picture between the t3^{th} moment and the t4^{th} moment satisfies a correlation degree requirement, and uses a start time and an end time of the second resource segment as the t5^{th} moment as the t6^{th} moment respectively.

14: The first terminal device changes the resource picture covered by the intercepting scale from a resource picture between the 13^{th} moment and the t4^{th} moment to a resource picture between the t5^{th} moment and the t6^{th} moment.

15: The first terminal device displays the resource picture between the 13^{th} moment and the t4^{th} moment in a first form.

16: The first terminal device displays the 13^{th} moment, the t4^{th} moment, the t5^{th} moment, and the t6^{th} moment in the time display area.

17: The first object clicks on the confirmation control, indicating that the first object intends to share the first resource segment and the second resource segment in the target multimedia resource.

18: The first terminal device generates a resource sharing card. Content displayed on the resource sharing card has been described in operation 203 above, and details are not described herein again.

19: The first terminal device displays a first page, where the resource sharing card is displayed on the first page.

20: The first terminal device determines a second object. A process of determining the second object is similar to the process of operation 203 above, and details are not described herein again.

21: The first terminal device transmits the resource sharing card to a second terminal device used by the second object.

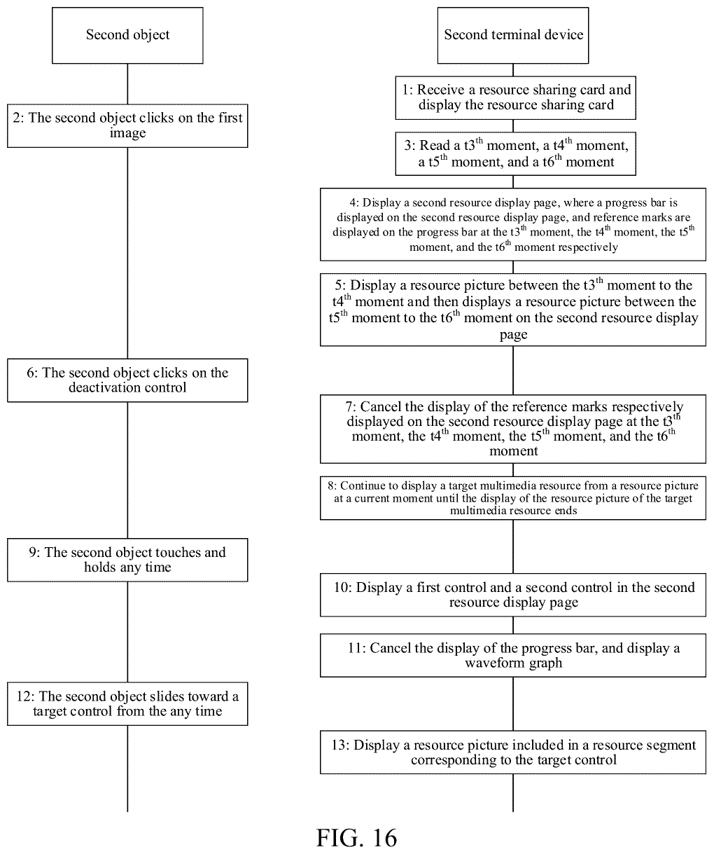

FIG. 16 is a flowchart of a multimedia resource sharing method according to an embodiment of the present disclosure. Execution bodies of the multimedia resource sharing method include a second object and a second terminal device. The second object is an object that uses the second terminal device. The method includes the following operations.

1: The second terminal device receives a resource sharing card and displays the resource sharing card.

A first image is displayed on the resource sharing card.

2: The second object clicks on the first image.

3: The second terminal device reads a t3^{th} moment, a t4^{th} moment, a t5^{th} moment, and a t6^{th} moment.

4: The second terminal device displays a second resource display page. A progress bar is displayed on the second resource display page, and reference marks are displayed on the progress bar at the t3^{th} moment, the t4^{th} moment, the t5^{th} moment, and the t6^{th} moment respectively.

5: The second terminal device displays a resource picture between the 13^{th} moment to the t4^{th} moment and then displays a resource picture between the t5^{th} moment to the 6^{th} moment on the second resource display page.

6: A deactivation control is further displayed on the second resource display page. The second object clicks on the deactivation control.

7: The second terminal device cancels the display of the reference marks respectively displayed on the second resource display page at the t3^{th} moment, the t4^{th} moment, the t5^{th} moment, and the t6^{th} moment.

8: The second resource device continues to display a target multimedia resource from a resource picture at a current moment until the display of the resource picture of the target multimedia resource ends.

The current moment is a moment at which the resource picture displayed on the second resource display page is in the target multimedia resource when the second object clicks on the deactivation control.

9: The second object touches and holds any time.

10: The second terminal device displays a first control and a second control in the second resource display page.

11: The second terminal device cancels the display of the progress bar, and displays a waveform graph.

12: The second object slides toward a target control from the any time. The target control is any one of the first control and the second control.

13: The second terminal device displays a resource picture included in a resource segment corresponding to the target control.

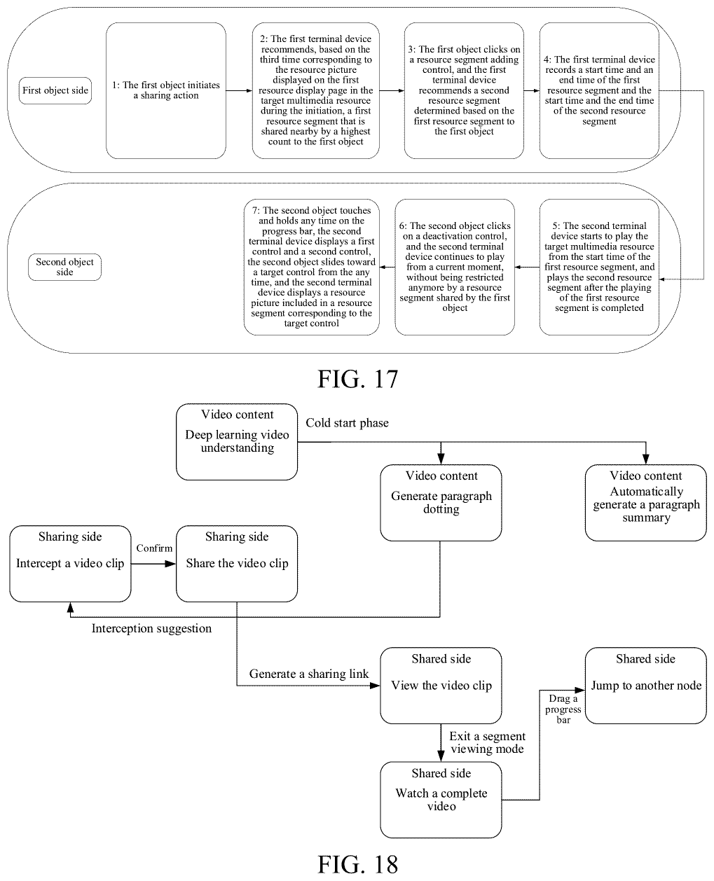

FIG. 17 is a schematic diagram of a multimedia resource sharing method according to an embodiment of the present disclosure. The method is described by interaction among a first object, a first terminal device, a second object, a second terminal device, and a server. The method includes:

1: The first object initiates a sharing action.

The first terminal device receives a trigger operation by the first object for a sharing control, and transmits, to the server, a third time corresponding to a resource picture displayed on a first resource display page in a target multimedia resource during the trigger operation for the sharing control.

2: The first terminal device recommends, based on the third time corresponding to the resource picture displayed on the first resource display page in the target multimedia resource during the initiation, a first resource segment that is shared nearby by a highest count to the first object.

The server determines a first time and a second time based on the third time, and transmits the first time and the second time to the first terminal device. The first terminal device covers a resource picture between the first time and the second time with an intercepting scale displayed on a resource segment selection control.

3: The first object clicks on a resource segment adding control, and the first terminal device recommends a second resource segment determined based on the first resource segment to the first object.

The server determines the second resource segment based on the first resource segment, and transmits a start time and an end time of the second resource segment to the first terminal device. The first terminal device changes a start time and an end time of the intercepting scale displayed on the resource segment selection control to the start time of the second resource segment and the end time of the second resource segment respectively.

4: The first terminal device records a start time and an end time of the first resource segment and the start time and the end time of the second resource segment.

The server records the start time and the end time of the first resource segment and the start time and the end time of the second resource segment. The first terminal device adjusts the quantity of sharing of the first resource segment and a quantity of sharing of the second resource segment.

5: The second terminal device starts to play the target multimedia resource from the start time of the first resource segment, and plays the second resource segment after the playing of the first resource segment is completed.

The server reads the start time and the end time of the first resource segment and the start time and the end time of the second resource segment; and transmits the start time and the end time of the first resource segment and the start time and the end time of the second resource segment to the second terminal device. The second terminal device obtains the start time and the end time of the first resource segment and the start time and the end time of the second resource segment; displays reference marks on a progress bar at the start time and the end time of the first resource segment and the start time and the end time of the second resource segment, and displays a progress bar between the start time and the end time of the first resource segment and a progress bar between the start time and the end time of the second resource segment in a target form; and starts to display a resource picture from the start time of the first resource segment.

6: The second object clicks on a deactivation control, and the second terminal device continues to play from a current moment, without being restricted anymore by a resource segment shared by the first object.

The second terminal device receives a deactivation instruction from the second object, and cancels the display of the reference marks on the progress bar at the start time and the end time of the first resource segment and the start time and the end time of the second resource segment. At least one second mark is displayed on the progress bar.

7: The second object touches and holds any time on the progress bar, the second terminal device displays a first control and a second control, the second object slides toward a target control from the any time, and the second terminal device displays a resource picture included in a resource segment corresponding to the target control.

The second terminal device receives a touch and hold operation by the second object for the any time, determines a third resource segment and a fourth resource segment, displays segment information of the third resource segment on the first control, and displays segment information of the fourth resource segment on the second control.

FIG. 18 is a schematic diagram of a multimedia resource sharing method according to an embodiment of the present disclosure.

Deep learning video understanding is performed on video content, paragraph dotting is formed, and a paragraph summary is automatically generated. For example, a manner of performing paragraph dotting may mean that one or more second marks are added to the progress bar of the target multimedia resource to obtain one or more paragraphs (that is, resource segments). That the paragraph summary is automatically generated may mean that semantic understanding is performed on each obtained paragraph to obtain semantics corresponding to the paragraph. The semantics are, for example, a topic of the resource segment.

A sharing side (corresponding to the foregoing first terminal device) intercepts a video clip, where the foregoing paragraph dotting is conducive to providing an interception suggestion in a process of intercepting the video clip, so that the sharing side determines a to-be-shared video clip that needs to be shared, generates a sharing link for the to-be-shared video clip, and then transmits the sharing link to a shared side (corresponding to the foregoing second terminal device). Therefore, the sharing side shares the video clip with the shared side.

The shared side views the video clip shared by the sharing side. When the shared side exits a segment viewing mode, the shared side views a complete video.

When the shared side drags the progress bar, the progress bar jumps to another node, and the shared side views a video of the another node.

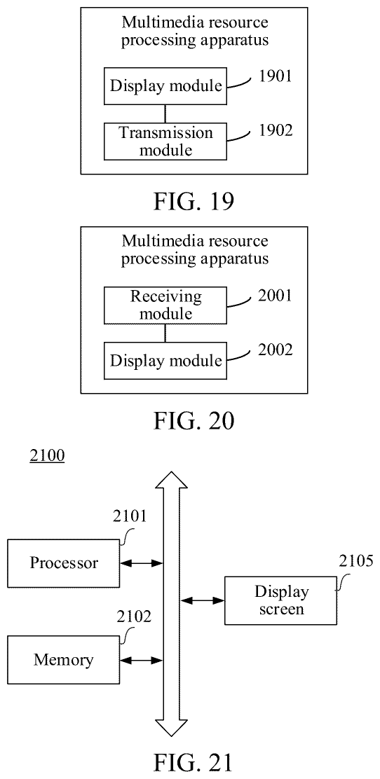

FIG. 19 is a schematic structural diagram of an implementation environment of a multimedia resource sharing apparatus according to an embodiment of the present disclosure (because sharing is a type of processing, each multimedia resource sharing apparatus in the embodiments of the present disclosure may be considered as a multimedia resource processing apparatus). As shown in FIG. 19, the apparatus includes:

a display module 1901, configured to display a first resource display page, where a first resource picture and a sharing control of a target multimedia resource are displayed on the first resource display page, or a sharing control and a first resource picture are displayed on the first resource display page, the sharing control is configured to share a target multimedia resource, the target multimedia resource has a plurality of resource pictures, and the first resource picture is one of the plurality of resource pictures, or the first resource picture is one resource picture representing the target multimedia resource;

the display module 1901 is further configured to: display a resource segment selection control in the first resource display page in response to a trigger operation for the sharing control, where selectable resource pictures of the target multimedia resource at a plurality of times are displayed on the resource segment selection control, or the display module 1901 is further configured to: display a resource segment selection control in the first resource display page in response to a trigger operation for the sharing control, a second resource picture being displayed on the resource segment selection control, and the second resource picture being at least one of the plurality of resource pictures of the target multimedia resource; and obtain a selected resource picture in the second resource picture, and determine a first resource segment according to the selected resource picture in the second resource picture; and
a transmission module 1902, configured to transmit a resource picture corresponding to a first resource segment to a second terminal device, where the resource picture corresponding to the first resource segment includes a selected resource picture at the at least one time in the resource pictures at the plurality of times, or a transmission module 1902, configured to transmit the first resource segment to a second terminal device, the first resource segment including the selected resource picture in the second resource picture.

In one embodiment, a start time of the first resource segment is a first time, an end time of the first resource segment is a second time, and each resource picture included in the plurality of resource pictures corresponds to a time in the target multimedia resource; and the apparatus further includes:

a determining module, configured to: determine, in response to the trigger operation for the sharing control, a third time of a resource picture displayed on the first resource display page in the target multimedia resource when the sharing control is triggered (determine the third time corresponding to the resource picture displayed on the first resource display page when the sharing control is triggered, where the resource picture displayed on the first resource display page when the sharing control is triggered is one of the plurality of resource pictures); use, in resource pictures corresponding to times in a target time period, a time corresponding to a resource picture whose quantity of sharing times satisfies a quantity requirement as the first time (use, in resource pictures corresponding to times in a target period of time, a time corresponding to a resource picture whose sharing count satisfies a count requirement as the first time, where the resource pictures corresponding to the times in the target period of time are at least one of the plurality of resource pictures), where a start time of the target time period is a start time of the target multimedia resource, and an end time of the target time period is the third time; determine candidate resource segments in resource segments whose start times are the second time, where end times of the candidate resource segments are not earlier than the third time; and use an end time of a candidate resource segment whose sharing count satisfies the count requirement among the candidate resource segments as the second time.

For example, the display module is configured to: determine, in response to the trigger operation for the sharing control, a third time corresponding to a resource picture displayed on the first resource display page when the sharing control is triggered, where the resource picture displayed on the first resource display page when the sharing control is triggered is one of the plurality of resource pictures; use, in resource pictures corresponding to times in a target period of time, a resource picture whose sharing count satisfies a count requirement as the selected resource picture in the second resource picture, and use a time corresponding to the selected resource picture in the second resource picture as the first time, where the resource pictures corresponding to the times in the target period of time are at least one of the plurality of resource pictures, a start time of the target period of time is a start time of the target multimedia resource, and an end time of the target period of time is the third time; determine candidate resource segments in resource segments whose start times are the first time, where end times of the candidate resource segments are not earlier than the third time; use an end time of a candidate resource segment whose sharing count satisfies the count requirement among the candidate resource segments as the second time; and use a resource picture between the first time and the second time as the first resource segment.

In one embodiment, a resource segment adding control is further displayed on the resource segment selection control, and the resource segment adding control is configured to instruct to determine, based on that the first resource segment is determined, a second resource segment to be shared in the plurality of resource segments included in the target multimedia resource; and
the apparatus further includes:
a change module, configured to: in response to a trigger operation for the resource segment adding control, change a selected resource picture corresponding to the first resource segment in the resource segment selection control to a resource picture corresponding to the second resource segment (change a selected resource picture in the resource segment selection control from the resource picture included in the first resource segment to a resource picture included in the second resource segment), where a correlation degree between the second resource segment and the first resource segment satisfies a correlation degree requirement; and
the transmission module 1902 is configured to transmit the resource picture corresponding to the first resource segment and the resource picture corresponding to the second resource segment to the second terminal device (transmit the first resource segment and the second resource segment to the second terminal device).

In one embodiment, the display module 1901 is further configured to display, in response to a trigger operation for the resource segment adding control, a resource picture corresponding to the first resource segment (namely, a resource picture included in the first resource segment) displayed on the resource segment selection control in a first form, where the first form is configured for indicating that the start time and the end time of the first resource segment cannot be adjusted (the first form is configured for indicating that the start time of the first resource segment and the end time of the first resource segment remain unchanged).

In one embodiment, the determining module is further configured to: obtain a first feature vector of the first resource segment in response to the trigger operation for the resource segment adding control, where the first feature vector is configured for representing the resource picture corresponding to the first resource segment; obtain a second feature vector of each reference resource segment, where the reference resource segment is a resource segment in which resource pictures included in the plurality of resource segments included in the target multimedia resource are not duplicated with a resource picture corresponding to the first resource segment (the reference resource segment is at least one of the plurality of resource segments included in the target multimedia resource, a resource picture included in the reference resource segment is not duplicated with the resource picture included in the first resource segment), and a second feature vector of any reference resource segment is configured for representing a resource picture corresponding to the any reference resource segment (a resource picture included in the any reference resource segment); determine a correlation degree between each reference resource segment and the first resource segment according to the second feature vector of the reference resource segment and the first feature vector of the first resource segment; and use a reference resource segment whose correlation degree satisfies the correlation degree requirement as the second resource segment.

In one embodiment, the determining module is further configured to: segment the target multimedia resource to obtain a plurality of resource segments included in the target multimedia resource; and use a resource segment in the plurality of resource segments other than a target resource segment as the reference resource segment, where a resource picture corresponding to the target resource segment (namely, a resource picture included in the target resource segment) is duplicated with the resource picture corresponding to the first resource segment. The start time and the end time of each resource segment may be configured for determining the target resource segment from the plurality of resource segments.

In one embodiment, a confirmation control is further displayed on the first resource display page;
the display module 1901 is further configured to display a first page in response to a trigger operation for the confirmation control, where a resource sharing card and a plurality of sharing channel controls are displayed on the first page, and the resource sharing card is configured for sharing the resource picture corresponding to the first resource segment;
the determining module is further configured to determine, in response to a trigger operation for a target channel sharing control of the plurality of channel sharing controls, a second object based on that the target channel sharing control is triggered; and
the transmission module 1902 is configured to transmit the resource sharing card to the second terminal device used by the second object.

In one embodiment, a progress bar is displayed on the resource sharing card, the progress bar is a progress bar of the target multimedia resource, and a first reference mark and a second reference mark are displayed on the progress bar; a time corresponding to the first reference mark on the progress bar is the first time, and a time corresponding to the second reference mark on the progress bar is the second time; and A progress bar between the first reference mark and the second reference mark is displayed in a target form, and the target form is configured for instructing to share a resource picture between the first time and the second time.

In one embodiment, at least one of first prompt information, a first image, a second image, and second prompt information is displayed on the resource sharing card.

The first prompt information is configured for indicating a position of the first resource segment in the target multimedia resource, the first image is any one of resource pictures included in the first resource segment, the second image is any resource picture included in the target multimedia resource (any one of the plurality of resource pictures of the target multimedia resource), the second prompt information is resource information of the target multimedia resource, and the resource information includes at least one of a resource name, object information of a resource posting object, a resource posting time, and a resource posting address.

In one embodiment, a time display area is further displayed on the resource segment selection control, and the time display area is configured for displaying the start time of the first resource segment and the end time of the first resource segment.

In one embodiment, a select-all control is further displayed on the resource segment selection control, and the select-all control is configured to instruct to share the target multimedia resource; and
the change module is further configured to change, in response to a trigger operation for the select-all control, the selected resource picture that corresponds to the first resource segment and that is in the resource segment selection control to resource pictures corresponding to the target multimedia resource (the plurality of resource pictures of the target multimedia resource).

In one embodiment, a waveform graph is further displayed on the resource segment selection control, and the waveform graph is configured for indicating sharing counts of resource pictures of the target multimedia resource at times.

In the foregoing apparatus, during sharing of a multimedia resource, when a trigger operation for a sharing control is received, a resource segment selection control is displayed on a first resource display page, and then a resource picture corresponding to a first resource segment is shared with a second terminal device. The resource picture corresponding to the first resource segment includes a selected resource picture at the at least one time in resource pictures at a plurality of times, so that resource sharing of the multimedia resource is more targeted, sharing manners of the multimedia resource are diversified, and sharing flexibility of the multimedia resource is improved.

FIG. 20 is a schematic structural diagram of a multimedia resource sharing apparatus according to an embodiment of the present disclosure. As shown in FIG. 20, the apparatus includes:
a receiving module 2001, configured to receive a resource picture corresponding to a first resource segment included in a target multimedia resource transmitted by a first terminal device (namely, receive a first resource segment included in a target multimedia resource transmitted by a first terminal device), where a start time of the first resource segment is a first time, an end time of the first resource segment is a second time, the first resource segment includes a selected resource picture in a second resource picture, and the second resource picture is at least one of a plurality of resource pictures of the target multimedia resource; and
a display module 2002, configured to display a second resource display page, where a target resource picture and a progress bar are displayed on the second resource display page, the target resource picture is a resource picture corresponding to the first time, the progress bar is a progress bar of the target multimedia resource, a first reference mark and a second reference mark are displayed on the progress bar, a time corresponding to the first reference mark on the progress bar is the first time, a time corresponding to the second reference mark on the progress bar is the second time, a progress bar between the first reference mark and the second reference mark is displayed in a target form, and the target form is configured for instructing to share a resource picture between the first time and the second time.

In one embodiment, third prompt information and a deactivation control corresponding to the third prompt information are further displayed on the second resource display page, the third prompt information is configured for indicating a quantity of resource segments shared by the first terminal device with the second terminal device, and the deactivation control is configured to instruct to cancel display of the resource segments shared by the first terminal device with the second terminal device; and
the display module 2002 is configured to cancel, in response to a trigger operation for the deactivation control, display of the first reference marker and the second reference marker on the progress bar, and display at least one second marker on the progress bar, where the second marker is configured for indicating a resource segment included in the target multimedia resource.

In one embodiment, the display module 2002 is further configured to display a first control and a second control in the second resource display page in response to a target operation for any time on the progress bar, where the first control is configured to display segment information of a resource segment adjacent to a target resource segment and previous to the target resource segment, the second control is configured to display segment information of a resource segment adjacent to the target resource segment and subsequent to the target resource segment, the target resource segment is a resource segment at the any time, and the segment information includes at least one of a topic of the resource segment and a start time of the resource segment.

In one embodiment, the display module 2002 is further configured to display, in response to receiving a slide operation to a target control from the any time, a resource picture included in a resource segment corresponding to the target control in the second resource display page, where the target control is either of the first control and the second control.

In one embodiment, the receiving module 2001 is configured to receive a resource sharing card transmitted by the first terminal device, where the resource sharing card is configured to share the resource picture corresponding to the first resource segment included in the target multimedia resource; and
the display module 2002 is configured to display the second resource display page in response to a trigger operation for the resource sharing card.

In the foregoing apparatus, the resource picture corresponding to the first resource segment shared by the first terminal device is received, and then the resource picture corresponding to the first resource segment is displayed, so that resource sharing of the multimedia resource is more targeted, sharing manners of the multimedia resource are diversified, and sharing flexibility of the multimedia resource is improved.

When the apparatus provided above implements the functions of the apparatus, only division of the foregoing function modules is used as an example for description. In the practical application, the functions may be allocated to and completed by different function modules according to requirements. That is, an internal structure of the device is divided into different function modules, to complete all or some of the functions described above. In addition, the apparatus provided in the foregoing embodiments and the method embodiments fall within a same conception. For details of a specific implementation process, refer to the method embodiments. Details are not described herein again.

FIG. 21 shows a structural block diagram of a terminal device 2100 according to an exemplary embodiment of the present disclosure. The terminal device 2100 may be a portable mobile terminal, for example, a smartphone, a tablet computer, a Moving Picture Experts Group Audio Layer III (MP3) player, a Moving Picture Experts Group Audio Layer IV (MP4) player, a notebook computer, or a desktop computer. The terminal device 2100 may also be referred to as another name such as user equipment, a portable terminal, a laptop terminal, or a desktop terminal.

The terminal device 2100 includes: a processor 2101 and a memory 2102.

The processor 2101 may include one or more processing cores, for example, a 4-core processor or an 8-core processor. The processor 2101 may be implemented in at least one hardware form of a digital signal processor (DSP), a Field-Programmable Gate Array (FPGA), and a Programmable Logic Array (PLA). The processor 2101 may alternatively include a main processor and a coprocessor. The main processor is configured to process data in an awake state, and is also referred to as a Central Processing Unit (CPU). The coprocessor is a low power consumption processor configured to process data in a standby state. In some embodiments, the processor 2101 may be integrated with a Graphics Processing Unit (GPU). The GPU is configured to render and draw content that needs to be displayed on a display screen. In some embodiments, the processor 2101 may further include an Artificial Intelligence (AI) processor. The AI processor is configured to process computing operations related to machine learning.

The memory 2102 may include one or more computer-readable storage media. The computer-readable storage medium may be non-transient. The memory 2102 may further include a high-speed random access memory and a non-volatile memory, for example, one or more disk storage devices or flash storage devices. In some embodiments, the non-transitory computer-readable storage medium in the memory 2102 is configured to store at least one instruction. The at least one instruction is configured to be executed by the processor 2101 to implement the multimedia resource sharing method provided in the method embodiments of the present disclosure.

In some embodiments, the terminal device 2100 includes: a display screen 2105. For example, the display screen 2105 is configured to display content such as a resource display page.

The display screen 2105 is configured to display a User Interface (UI). The UI may include a graph, text, an icon, a video, and any combination thereof. When the display screen 2105 is a touch display screen, the display screen 2105 further has a capability of collecting a touch signal on or above a surface of the display screen 2105. The touch signal may be inputted to the processor 2101 as a control signal for processing. In this case, the display screen 2105 may be further configured to provide a virtual button and/or a virtual keyboard, also referred to as a soft button and/or a soft keyboard. In some embodiments, there may be one display screen 2105 arranged on a front panel of the terminal device 2100. In some other embodiments, there may be at least two display screens 2105, arranged on different surfaces of the terminal device 2100 respectively or in a folded design. In some other embodiments, the display screen 2105 may be a flexible display screen, disposed on a curved surface or a folded surface of the terminal device 2100. Even further, the display screen 2105 may be arranged in a non-rectangular irregular graph, that is, a special-shaped screen. The display screen 2105 may be prepared by using materials such as a liquid-crystal display (LCD), an organic light-emitting diode (OLED), or the like.

A person skilled in the art may understand that the structure shown in FIG. 21 constitutes no limitation on the terminal device 2100, and the terminal may comprise more or fewer components than those shown in the figure, or some components may be combined, or a different component deployment may be used.

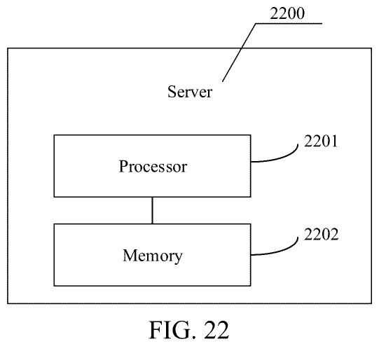

FIG. 22 is a schematic structural diagram of a server according to an embodiment of the present disclosure. The server 2200 may vary greatly because a configuration or performance varies, and may comprise one or more central processing units (CPU) 2201 and one or more memories 2202. The one or more memories 2202 store at least one piece of program code, and the at least one piece of program code is loaded and executed by the one or more processors 2201 to implement the multimedia resource sharing methods provided in the foregoing various method embodiments. Certainly, the server 2200 may also have a wired or wireless network interface, a keyboard, an input/output interface and other components to facilitate input/output. The server 2200 may also include other components for implementing device functions. Details are not described herein again.

In an exemplary embodiment, a computer-readable storage medium is further provided. The storage medium has at least one piece of program code stored therein, and the at least one piece of program code is loaded and executed by a processor, to enable a computer device to implement any one of the foregoing multimedia resource sharing methods.

In one embodiment, the foregoing computer readable storage medium may be a read-only memory (ROM), a random access memory (RAM), a compact disc read-only memory (CD-ROM), a magnetic tape, a floppy disk, an optical data storage device, or the like.

In an exemplary embodiment, a computer program or a computer program product is further provided. The computer program or the computer program product has at least one computer instruction stored therein, and the at least one computer instruction is loaded and executed by a processor, to enable a computer device to implement any one of the foregoing multimedia resource sharing methods.

As such, according to various embodiments of the present disclosure, during sharing of a multimedia resource, when a trigger operation for a sharing control is received, a resource segment selection control is displayed on a first resource display page, and then a resource picture corresponding to a first resource segment is shared with a second terminal device. The resource picture corresponding to the first resource segment includes a selected resource picture at the at least one time in resource pictures at a plurality of times, so that resource sharing of the multimedia resource is more targeted, sharing manners of the multimedia resource are diversified, and sharing flexibility of the multimedia resource is improved. The sharing of the multimedia resource is a type of processing of the multimedia resource.

Information (including but not limited to user equipment information, user personal information, and the like), data (including but not limited to data for analysis, stored data, displayed data, and the like), and signals involved in the present disclosure are all authorized by users or fully authorized by all parties, and collection, use, and processing of relevant data need to comply with relevant laws, regulations, and standards of relevant countries and areas. For example, the resource display page, the sharing counts of the resource pictures, and the resource segment sharing count involved in the present disclosure are all obtained under full authorization.

The “plurality of” described in this specification refers to two or more. The “and/or” describes an association relationship for describing associated objects and represents that three relationships may exist. For example, A and/or B may represent the following three cases: Only A exists, both A and B exist, and only B exists. The character “/” in this specification indicates an “or” relationship between the associated objects.

The sequence numbers of the foregoing embodiments of the present disclosure are merely for illustrative purposes, and are not intended to indicate priorities of the embodiments.

The foregoing descriptions are merely exemplary embodiments of the present disclosure, but are not intended to limit the present disclosure. Any modification, equivalent replacement, or improvement made within the principle of the present disclosure shall fall within the protection scope of the present disclosure.

What is claimed is:

1. A multimedia resource processing method, performed by a terminal device, the method comprising:
displaying a first resource display page, a sharing control and a first resource picture being displayed on the first resource display page, the sharing control being configured to share a target multimedia resource, the target multimedia resource having a plurality of resource pictures, and the first resource picture being one of the plurality of resource pictures, or the first resource picture being one resource picture representing the target multimedia resource;
displaying a resource segment selection control in the first resource display page in response to a trigger operation for the sharing control, a second resource picture being displayed on the resource segment selection control, and the second resource picture being at least one of the plurality of resource pictures of the target multimedia resource;
obtaining a selected resource picture in the second resource picture, and determining a first resource segment according to the selected resource picture in the second resource picture; and
transmitting the first resource segment to another terminal device, the first resource segment comprising the selected resource picture in the second resource picture.

2. The method according to claim 1, wherein a start time of the first resource segment is a first time, an end time of the first resource segment is a second time, and a resource picture in the plurality of resource pictures corresponds to a time in the target multimedia resource; and
obtaining the selected resource picture in the second resource picture, and determining the first resource segment according to the selected resource picture in the second resource picture comprises:
determining, in response to the trigger operation for the sharing control, a third time corresponding to a resource picture displayed on the first resource display page when the sharing control is triggered, wherein the resource picture displayed on the first resource display page when the sharing control is triggered is one of the plurality of resource pictures;
using, in resource pictures corresponding to times in a target period of time, a resource picture whose sharing count satisfies a count requirement as the selected resource picture in the second resource picture, and using a time corresponding to the selected resource picture in the second resource picture as the first time, wherein the resource pictures corresponding to the times in the target period of time are at least one of the plurality of resource pictures, a start time of the target period of time is a start time of the target multimedia resource, and an end time of the target period of time is the third time;
determining candidate resource segments in resource segments whose start times are the first time, wherein end times of the candidate resource segments are not earlier than the third time;
using an end time of a candidate resource segment whose sharing count satisfies the count requirement among the candidate resource segments as the second time; and
using a resource picture between the first time and the second time as the first resource segment.

3. The method according to claim 1, wherein a resource segment adding control is further displayed on the resource segment selection control, and the resource segment adding control is configured to instruct to determine, based on that the first resource segment is determined, a second resource segment to be shared in the plurality of resource segments comprised in the target multimedia resource;
the method further comprising:
changing, in response to a trigger operation for the resource segment adding control, a selected resource picture in the resource segment selection control from the resource picture comprised in the first resource segment to a resource picture comprised in the second resource segment, wherein a correlation degree between the second resource segment and the first resource segment satisfies a correlation degree requirement; and
transmitting the first resource segment to another terminal device comprises:
transmitting the first resource segment and the another resource segment to the second terminal device.

4. The method according to claim 3, further comprising:
displaying, in response to the trigger operation for the resource segment adding control, a resource picture comprised in the first resource segment and displayed on the resource segment selection control into a first form, wherein the first form is configured for indicating that a start time of the first resource segment and an end time of the first resource segment remain unchanged.

5. The method according to claim 3, further comprising:
obtaining a first feature vector of the first resource segment in response to the trigger operation for the resource segment adding control, wherein the first feature vector is configured for representing the resource picture comprised in the first resource segment;
obtaining a second feature vector of each reference resource segment, wherein the reference resource segment is at least one of the plurality of resource segments comprised in the target multimedia resource, a resource picture comprised in the reference resource segment is not duplicated with the resource picture comprised in the first resource segment, and a second feature vector of any reference resource segment is configured for representing a resource picture comprised in the any reference resource segment;
determining a correlation degree between each reference resource segment and the first resource segment according to the second feature vector of the reference resource segment and the first feature vector of the first resource segment; and
using a reference resource segment whose correlation degree satisfies the correlation degree requirement as the second resource segment.

6. The method according to claim 5, further comprising:
segmenting the target multimedia resource to obtain a plurality of resource segments comprised in the target multimedia resource; and
using a resource segment in the plurality of resource segments other than a target resource segment as the reference resource segment, wherein a resource picture comprised in the target resource segment is duplicated with the resource picture comprised in the first resource segment.

7. The method according to claim 1, wherein a confirmation control is further displayed on the first resource display page;
after displaying the resource segment selection control in the first resource display page, the method further comprises:
displaying a first page in response to a trigger operation for the confirmation control, wherein a resource sharing card and a plurality of sharing channel controls are displayed on the first page, and the resource sharing card is configured for sharing the resource picture comprised in the first resource segment; and
determining, in response to a trigger operation for a target channel sharing control of the plurality of channel sharing controls, a second object based on that the target channel sharing control is triggered; and
transmitting the first resource segment to the another terminal device comprises:
transmitting the resource sharing card to the another terminal device used by the second object.

8. The method according to claim 7, wherein a progress bar is displayed on the resource sharing card, the progress bar is a progress bar of the target multimedia resource, and a first reference mark and a second reference mark are displayed on the progress bar;
a time corresponding to the first reference mark on the progress bar is the first time, and a time corresponding to the second reference mark on the progress bar is the second time; and a progress bar between the first reference mark and the second reference mark is displayed in a target form, and the target form is configured for instructing to share a resource picture between the first time and the second time.

9. The method according to claim 7, wherein at least one of first prompt information, a first image, a second image, or second prompt information is displayed on the resource sharing card,
wherein the first prompt information is configured for indicating a position of the first resource segment in the target multimedia resource, the first image is any one of resource pictures comprised in the first resource segment, the second image is any one of the plurality of resource pictures of the target multimedia resource, the second prompt information is resource information of the target multimedia resource, and the resource information comprises at least one of a resource name, object information of a resource posting object, a resource posting time, or a resource posting address.

10. The method according to claim 1, wherein a time display area is further displayed on the resource segment selection control, and the time display area is configured for displaying the start time of the first resource segment and the end time of the first resource segment.

11. The method according to claim 1, wherein a select-all control is further displayed on the resource segment selection control, and the select-all control is configured to instruct to share the target multimedia resource; and
the method further comprises:
changing, in response to a trigger operation for the select-all control, the selected resource picture that is comprised in the first resource segment and that is in the resource segment selection control to the plurality of resource pictures of the target multimedia resource.

12. The method according to claim 1, wherein a waveform graph is further displayed on the resource segment selection control, and the waveform graph is configured for indicating sharing counts of the plurality of resource pictures of the target multimedia resource.

13. A computer device, comprising:
one or more processors and a memory containing at least one piece of program code that, when being executed, causes the one or more processors to perform:
displaying a first resource display page, a sharing control and a first resource picture being displayed on the first resource display page, the sharing control being configured to share a target multimedia resource, the target multimedia resource having a plurality of resource pictures, and the first resource picture being one of the plurality of resource pictures, or the first resource picture being one resource picture representing the target multimedia resource;
displaying a resource segment selection control in the first resource display page in response to a trigger operation for the sharing control, a second resource picture being displayed on the resource segment selection control, and the second resource picture being at least one of the plurality of resource pictures of the target multimedia resource;
obtaining a selected resource picture in the second resource picture, and determining a first resource segment according to the selected resource picture in the second resource picture; and
transmitting the first resource segment to a terminal device, the first resource segment comprising the selected resource picture in the second resource picture.

14. The device according to claim 13, wherein a start time of the first resource segment is a first time, an end time of the first resource segment is a second time, and a resource picture in the plurality of resource pictures corresponds to a time in the target multimedia resource; and the one or more processors are further configured to perform:
determining, in response to the trigger operation for the sharing control, a third time corresponding to a resource picture displayed on the first resource display page when the sharing control is triggered, wherein the resource picture displayed on the first resource display page when the sharing control is triggered is one of the plurality of resource pictures;
using, in resource pictures corresponding to times in a target period of time, a resource picture whose sharing count satisfies a count requirement as the selected resource picture in the second resource picture, and using a time corresponding to the selected resource picture in the second resource picture as the first time, wherein the resource pictures corresponding to the times in the target period of time are at least one of the plurality of resource pictures, a start time of the target period of time is a start time of the target multimedia resource, and an end time of the target period of time is the third time;
determining candidate resource segments in resource segments whose start times are the first time, wherein end times of the candidate resource segments are not earlier than the third time;
using an end time of a candidate resource segment whose sharing count satisfies the count requirement among the candidate resource segments as the second time; and
using a resource picture between the first time and the second time as the first resource segment.

15. The device according to claim 13, wherein a resource segment adding control is further displayed on the resource segment selection control, and the resource segment adding control is configured to instruct to determine, based on that the first resource segment is determined, a second resource segment to be shared in the plurality of resource segments comprised in the target multimedia resource; and the one or more processors are further configured to perform:
changing, in response to a trigger operation for the resource segment adding control, a selected resource picture in the resource segment selection control from the resource picture comprised in the first resource segment to a resource picture comprised in the second resource segment, wherein a correlation degree between the second resource segment and the first resource segment satisfies a correlation degree requirement; and
transmitting the first resource segment and the another resource segment to the second terminal device.

16. The device according to claim 15, wherein the one or more processors are further configured to perform:
displaying, in response to the trigger operation for the resource segment adding control, a resource picture comprised in the first resource segment and displayed on the resource segment selection control into a first form, wherein the first form is configured for indicating that a start time of the first resource segment and an end time of the first resource segment remain unchanged.

17. The device according to claim 15, wherein the one or more processors are further configured to perform:
obtaining a first feature vector of the first resource segment in response to the trigger operation for the resource segment adding control, wherein the first feature vector is configured for representing the resource picture comprised in the first resource segment;
obtaining a second feature vector of each reference resource segment, wherein the reference resource segment is at least one of the plurality of resource segments comprised in the target multimedia resource, a resource picture comprised in the reference resource segment is not duplicated with the resource picture comprised in the first resource segment, and a second feature vector of any reference resource segment is configured for representing a resource picture comprised in the any reference resource segment;
determining a correlation degree between each reference resource segment and the first resource segment according to the second feature vector of the reference resource segment and the first feature vector of the first resource segment; and
using a reference resource segment whose correlation degree satisfies the correlation degree requirement as the second resource segment.

18. The device according to claim 17, wherein the one or more processors are further configured to perform:
segmenting the target multimedia resource to obtain a plurality of resource segments comprised in the target multimedia resource; and
using a resource segment in the plurality of resource segments other than a target resource segment as the reference resource segment, wherein a resource picture comprised in the target resource segment is duplicated with the resource picture comprised in the first resource segment.

19. The device according to claim 13, wherein a confirmation control is further displayed on the first resource display page; and the one or more processors are further configured to perform:
displaying a first page in response to a trigger operation for the confirmation control, wherein a resource sharing card and a plurality of sharing channel controls are displayed on the first page, and the resource sharing card is configured for sharing the resource picture comprised in the first resource segment; and
determining, in response to a trigger operation for a target channel sharing control of the plurality of channel sharing controls, a second object based on that the target channel sharing control is triggered; and
transmitting the resource sharing card to the terminal device used by the second object.

20. A non-transitory computer-readable storage medium containing at least one piece of program code that, when being executed, causes at least one processor to perform:
displaying a first resource display page, a sharing control and a first resource picture being displayed on the first resource display page, the sharing control being configured to share a target multimedia resource, the target multimedia resource having a plurality of resource pictures, and the first resource picture being one of the plurality of resource pictures, or the first resource picture being one resource picture representing the target multimedia resource;
displaying a resource segment selection control in the first resource display page in response to a trigger operation for the sharing control, a second resource picture being displayed on the resource segment selection control, and the second resource picture being at least one of the plurality of resource pictures of the target multimedia resource;
obtaining a selected resource picture in the second resource picture, and determining a first resource segment according to the selected resource picture in the second resource picture; and
transmitting the first resource segment to a terminal device, the first resource segment comprising the selected resource picture in the second resource picture.
